(19) United States
(12) Patent Application Publication
(10) Pub. No.: US 2009/0090238 A1
(43) Pub. Date: Apr. 9, 2009

(54) Torque Motor

(76) Inventor: Thomas Friedrich, Bad Wiessee (DE)

Correspondence Address: JACOBSON HOLMAN PLLC, 400 SEVENTH STREET N.W., SUITE 600, WASHINGTON, DC, 20004, US

(21) Appl. No.: 12/224,832

(22) PCT Filed: Mar. 7, 2007
(86) PCT No.: PCT/EP2007/001966

§ 371 Date: Sep. 8, 2008

(30) Foreign Application Priority Data
Mar. 7, 2006 (DE) 20 2006 003 589.3

(51) Int. Cl. F15B 15/06

(52) U.S. Cl. 91/508; 74/25

(57) ABSTRACT

The present invention relates to a rotary motor, preferably a pivot drive for construction machinery, hoisting gear, trucks and the like, comprising an elongate, approximately tubular housing, at least one piston which is axially displaceably received in the housing and which can be axially driven by the charging of a pressure medium in a pressure chamber as well as at least one shaft which is received axially fixedly in the housing and rotatably around an axis of rotation, with the piston having a shaft passage cut-out by which the piston is axially displaceably seated on the shaft. In accordance with the invention, the shaft forms a crankshaft whose axis of rotation is offset with respect to the shaft passage cut-out. The shaft piece respectively passing through the shaft passage cut-out has a lever arm which is opposite the axis of rotation of the shaft and which translates the radial force at the engagement between the shaft and the piston which arises due to the axial displacement of the piston and the pitch of the spiral engagement track between the shaft and piston and/or between the piston and the housing into a rotary movement of the shaft with respect to the housing or vice versa. To achieve favorable force output conditions, provision is in particular made in this respect for the shaft passage cut-out to be arranged approximately centrally in the piston with respect to the cross-sectional surface of the piston, with a security against rotation of the piston being omitted so that a rotatability of the piston with respect to the housing is given.

The present invention relates to a rotary motor, preferably a pivot drive for construction machinery, hoisting gear, trucks and the like, comprising an elongate, approximately tubular housing, at least one piston which is axially displaceably received in the housing and which can be axially driven by the charging of a pressure medium in a pressure chamber as well as at least one shaft which is received axially fixedly in the housing and rotatably around an axis of rotation, with the piston having a shaft passage cut-out by which the piston is axially displaceably seated on the shaft.

With such rotary motors, the axial movement of the piston, which can be acted on by a pressure medium via corresponding pressure chambers, is translated into a rotation of the shaft with respect to the housing or of the housing with respect to the shaft. As a rule, for this purpose, the shaft is in screw engagement with the piston which is in turn guided rotationally fixedly with respect to the housing. Such a rotary motor is shown, for example, in DE 201 07 206 in which the piston is guided rotationally fixedly at the inner jacket surface of the circularly cylindrical housing, on the one hand, and is in screw engagement on a threaded section of the shaft, on the other hand. If the piston is axially displaced in the housing by hydraulic charging or pneumatic charging, its axial movement is translated into a rotary movement of the shaft via the screw engagement. The sealing of the piston with respect to the shaft and/or with respect to the housing is a problem in this respect. DE 201 07 206 proposes providing the piston with a sealing section which is spaced apart from the screw engagement section and which slides and is sealed on a shaft sealing section for the sealing between the piston and the shaft. Piston constructions of this type are, however, disadvantageous with respect to the construction size and are associated with a high production effort. In addition, different force relationships result for the operation in different directions of rotation.

A rotary motor is furthermore known from JP 61-278606 A whose shaft has a spiral cam section on which a counterpiece slides which is inserted into the axially displaceable piston and which should effect a sealing. The design of both the shaft and the piston is very complicated here; in addition, no rotary movement which is constant over the whole adjustment path of the piston can be effected. JP 63-130905 A furthermore shows a rotary motor in which the shaft has a toothed arrangement which is in the shape of a screw thread and on which a matching toothed arrangement in the shape of a screw thread of the piston is seated. The sealing of the piston with respect to the piston rod should be effected solely by the engagement of a toothed arrangement of a screw, which naturally brings along corresponding leaks with high pressures and/or low viscosity media and only permits inefficient operation. Similar problems also result in this respect with the security against rotation of the piston with respect to the cylinder.

The known rotary motors with coarse-thread toothed arrangements moreover only achieve very poor efficiencies since very large losses result due to high areal pressing and surfaces affected by friction. The area of application of such rotary motors has hereby also remained limited to pressure media with lubricant portions to date.

Starting from this, it is the underlying object of the present invention to provide an improved rotary motor of the named type which avoids disadvantages of the prior art and further develops the latter in an advantageous manner. A cost-effective piston/shaft arrangement which is simple to seal should preferably be provided which permits the generation of high torques and a large swing angles with a favorable efficiency with a short motor construction length independently of the pressure medium used.

This object is solved in accordance with the invention by a rotary motor in accordance with claim 1. Preferred aspects of the invention are the subject of the dependent claims.

The present invention therefore departs from the previous approach of providing a screw engagement between the shaft and the piston and of converting the axial movement of the piston into a rotary movement between the shaft and the housing via a rotationally fixed guidance of the piston at the housing. The piston instead actuates the shaft in accordance with the crank principle in conjunction with the wedge effect of the pitch of a spiral engagement track. Surprisingly, in this respect, it is possible to depart from the approach previously always followed that the piston of rotary motors which translate an axial movement of the piston into a rotary movement of the shaft is to be secured against rotation in whatever form, which is overridden by the present invention. In accordance with the invention, the shaft forms a crankshaft whose axis of rotation is offset with respect to the shaft passage cut-out. The shaft piece respectively passing through the shaft passage cut-out has a lever arm which is opposite the axis of rotation of the shaft and which translates the radial force at the engagement between the shaft and the piston which arises due to the axial displacement of the piston and the pitch of the spiral engagement track between the shaft and piston and/or between the piston and the housing into a rotary movement of the shaft with respect to the housing or vice versa. To achieve favorable force output conditions, provision is in particular made in this respect for the shaft passage cut-out to be arranged approximately centrally in the piston with respect to the cross-sectional surface of the piston, with a security against rotation of the piston being omitted so that a rotatability of the piston with respect to the housing is given. Small moments of tilt and low locking forces result due to the arrangement of the shaft passage cut-out approximately at the center of area of the cross-sectional area of the piston, which is also supported by the rotatability of the piston and the lack of securities against rotation or separated guides. In addition, a maximum effective lever arm with small locking forces can simultaneously be achieved by the named central arrangement of the shaft passage hole. An off-center shaft passage hole could admittedly further increase the lever arm of the shaft per se, but opposing forces with a lever arm in the opposite direction would undo the effect again, particularly since in this case moments of tilt would have to be compensated, which would degrade the efficiency. The rotatability of the piston relative to the housing moreover generally enables a variable pitch of the shaft section.

The production effort can be substantially reduced with respect to previously customary coarse-thread toothed arrangements between the piston and the shaft or the piston and the housing since simple geometries can be selected for the piston and in particular also for the shaft. The forces can in particular be output over a large area and complicated embodiments of the seals between the piston and the shaft and also between the housing and the piston can be avoided; they are moreover not exposed to the strains which arise due to the torque transmission with screw thread toothed arrangements. The simple geometries of the shaft and also of the piston which can be used do not only promote a simple and cost-effective production per se, which can moreover be adapted easily and fast to changed installation dimensions, but also an improved surface quality at the shaft and at the piston, whereby friction losses can be reduced. Together with the lower surface pressing, this brings about a higher efficiency of the motor and moreover also permits a use without pressure media containing lubricants. Simple rotationally symmetrical production methods can be used for the manufacture of shaft, piston and cylinder. In a further development of the invention, the vortex technique can in particular be used for the shaft.

In a further development of the invention, the shaft has a helical extent around its axis of rotation. The crank section of the shaft is so-to-say spatially entangled around the axis of rotation in the form of a helix. The helical thread advantageously has a constant radial spacing from the axis of rotation of the shaft in this respect, whereas the pitch can vary considered in the axial direction. The helical crank section preferably has a constant pitch, however, to translate axial movements of the piston into a uniform rotary movement.

The housing can be a simple cylinder liner with a cylindrical inner jacket surface which can in particular be made in circular cylindrical form in the simplest embodiment of the invention since a rotationally fixed guidance of the piston in the housing is not necessary. With a cylinder liner circular in cross-section as well as a shaft likewise circular in cross-section, the eccentric amount of the shaft which determines the efficiency of the motor, i.e. the shaft jump, can correspond to approximately a quarter of the difference of cylinder diameter and shaft diameter, that is ε=¼(d_{z}−d_{w}). The best possible efficiency of the motor can hereby be achieved with a compact and simple design.

The crank section of the shaft could alternatively also have a straight extent parallel to its axis of rotation and spaced apart therefrom. To realize the crank principle, in this case, the housing could have a spirally rotated inner jacket surface so that, on an axial movement of the piston, it executes a screw-like movement around the axis of rotation of the shaft. The spirally rotated embodiment of the inner jacket surface of the housing can optionally also be provided with the previously described helical embodiment of the shaft in order so-to-say to add the pitches and accordingly to achieve a greater ratio between the axial adjustment movement of the piston and the rotary movement of the shaft relative to the housing.

In a further development of the invention, the surface pair of piston and housing and/or of piston and shaft effecting the force output simultaneously forms a sealing surface pair which seals the pressure chamber with respect to the action of pressure. An extremely short overall length can hereby be realized. In addition, in a further development of the invention, effective piston surface of equal size can be formed at both sides of the piston so that the complete piston surface can be used effectively with equal forces in both directions. The total inner diameter surface of the housing is practically available as the piston pressing surface, only reduced by the shaft cross-section, on both piston sides. The same torques can hereby be generated in both drive directions with the same hydraulic or pneumatic pressures. In addition, a maximum torque yield results for a given pressure.

In particular a respective at least one seal is used between the shaft and the shaft passage cut-out in the piston as well as between the outer jacket surface of the piston and the inner jacket surface of the housing. Simple sealing elements, for example in the form of proven standard ring seals, can be used thanks to the simple geometry of these inner jacket surfaces and/or outer jacket surfaces at the housing and shaft.

In accordance with a particularly advantageous embodiment of the invention, the seal is made in this respect such that respective pressure pockets are formed between the piston and the housing and/or between the piston and the shaft, said pressure pockets being able to be fed from the pressure chambers driving the piston. In particular respective mutually oppositely disposed peripheral sectors can be bounded by axially extending sealing elements in the peripheral direction at the outer jacket surface of the piston and/or at the jacket surface of the shaft passage cut-out in the piston so that the corresponding peripheral sectors each form a pressure pocket, with the one of the pressure pockets being able to be brought into flow communication with the pressure chamber on the one piston side and the oppositely disposed pressure pocket being able to be brought into flow communication with the pressure chamber on the oppositely disposed piston side. The pressure pockets are therefore fed from different sides of the piston. This is based on the consideration that the radial forces to be output always occur on the same side of the piston depending on the drive direction. The hydraulic pressure or pneumatic pressure occurring for the respective drive movement at the respective piston side is directed directly into a specific peripheral sector between the piston and the housing and/or between the shaft and the piston and is prevented by two axial sealing elements or sealing sections from flowing out of this peripheral sector onto the other piston side in which no radial forces are to be taken up. A considerable reduction of friction can hereby be achieved, which has a considerable influence on the efficiency of the rotary motor. The radial forces to be taken up can be taken up to a considerable degree by the hydraulic pressure or pneumatic pressure by such a pressure pocket formation and an intelligent seal arrangement. In a further development of the invention, a pressure relief and, optionally, a lubrication of the support sites of the shaft can be achieved, in an analog manner by a suitable pressure medium guidance and shape of the seals.

In a further development of the invention, security against excess pressure is provided between the two pressure chambers of the motor which has at least one excess pressure passage connecting the two pressure chambers and which is closed in the normal case, i.e. at pressures below a preset threshold value, by an excess pressure valve which only opens when the named threshold value is exceeded. The security against excess pressure can generally be integrated into the shaft in the form of a shaft cut-out. The security against rotation can advantageously, however, also be integrated into the piston, which in particular facilitates the introduction of the excess pressure passage with a helical extent of the shaft.

To achieve a favorable installation with a simple production and a favorable force output, the shaft can advantageously be supported at the housing at least one end by means of a support plate or support disk, with a releasable connection preferably be provided between the support plate and the shaft. A helically made cut-out can in particular be provided in the support plate, with a helical section of the shaft being received with an exact fit in it. The helical shaft section is advantageously axially and/or radially tensioned or anchored in the support plate cut-out by a shape matched element which can have different embodiments.

The shaft can be differently supported at its two ends, preferably by a fixed support at one end and a loose support at the other end so that the shaft is only axially fixed at one side.

In this respect, in an advantageous embodiment of the invention, the total design of the housing is constituted or the support of the shaft is made such that the shaft, together with the piston seated thereon and preferably also together with the support plate supporting the shaft, can be removed axially at one side of the housing, whereby the piston and the seals can be made accessible in a simple manner for the purpose of the sealing replacement or for maintenance. The motor can so-to-say have an asymmetrical design overall in this respect, in particular with respect to the end-face support sites.

The shaft or its crank section can generally have different cross-sectional geometries. In accordance with an advantageous embodiment of the invention, the shaft has a simple circular cross-section.

Alternatively to this, the shaft can also have a pressed flat cross-section, in particular an oval or ellipsoid cross-section. Advantages with respect to the output of the bending movement and the support of the deformation can hereby be achieved. The shaft can hereby in particular nestle better against a corresponding mating contour so that a better support can be achieved.

Alternatively, the shaft can also have different cross-sections made in the manner of polygons, which can be advantageous, in dependence on the application, with embodiments of longer construction for the compensation of bending forces.

The shaft can, in a further development of the invention, have an unchanging cross-section along its axis, which is optionally helically curved, with the shaft surface advantageously being made smooth without scores or projections, such as would be present with a screw thread toothed arrangement. The surface of the shaft can in particular correspond to a continuous envelope surface such as arises when, for example, a ball or an optionally differently shaped cross-sectional piece is moved along the optionally helically curved shaft axis. The shaft cross-sections therefore advantageously have an unchanging geometry without jumps or other irregularities such as toothed arrangement scores or the like along the optionally curved longitudinal axis. The shaft can advantageously be made as an endless section which is cut to size to the desired length in dependence on the use, with bearing pins optionally also being able to be shaped on.

In an advantageous further development of the invention, the shaft can have a shaped on bearing pin on one side, while, at the other side, the other shaft runs out in its helical section which is supported at a support plate.

In accordance with an embodiment of the invention, the bearing pin is advantageously larger than the shaft in the region of its helical section. The bearing pin can in particular approximately correspond to the envelope which envelopes the named helix or helical section of the shaft. The diameter d_{L} of the bearing pin in this respect advantageously amounts to the sum of four times the shaft jump and of the shaft diameter, that is d_{L}=4ε+d_{W}.

In particular with relatively large shaft diameters, bearing pins can also be provided which are smaller than the shaft diameter, with the bearing pin here advantageously corresponding to approximately the inner envelope of the helical contour to achieve ideal bending strength, with d_{L}=d_{W}−2ε advantageously applying.

The piston can likewise generally have different cross-sectional shapes. In accordance with an embodiment which is simple to manufacture and effects a compact construction size, the piston can have an outer periphery contour of circular annular shape, with in particular a circularly cylindrical outer jacket surface being able to be provided apart from receiving pockets for sealing elements.

Alternatively, the piston can also have a pressed flat outer peripheral contour, in particular an oval or ellipsoid outer peripheral contour, in particular in conjunction with a likewise pressed flat design of the shaft cross-section. The outer shaft surface can hereby nestle correspondingly against the housing wall. The outer peripheral contour of the piston can optionally also be made in the manner of a polygon. Any moments of tilt which occur can in particular also be reduced with pressed flat, oval or ellipsoid piston cross-sections.

The shaft passage cut-out in the piston can likewise have different cross-sectional shapes which, in a further development of the invention, are adapted to the respective shaft cross-section.

To minimize the friction losses and further improve the efficiency of the motor, a respective roller bearing, preferably in the form of a ball bushing, can be provided between the housing and the piston and/or the piston and the shaft. Furthermore, for the minimization of friction, wear-resistant and low-friction plastics can be used from which the piston can be made, with the sealing elements also being able to be shaped on at the same time if necessary.

In accordance with a further advantageous embodiment of the invention, the motor can also have two shafts which are driven by a common piston. For this purpose, the piston can have two shaft passage cut-outs through which a respective one of the shafts extends. The two shafts preferably have a helical extent around their respective axis of rotation and have a suitable thread offset so that the radial forces induced on the piston by the respective shaft compensate one another. The shafts are so-to-say arranged in opposite senses so that the radial forces which are to be output by the piston are directed toward one another and thus compensate one another.

The invention will be explained in more detail in the following with reference to preferred embodiments and to associated drawings. There are shown in the drawings:

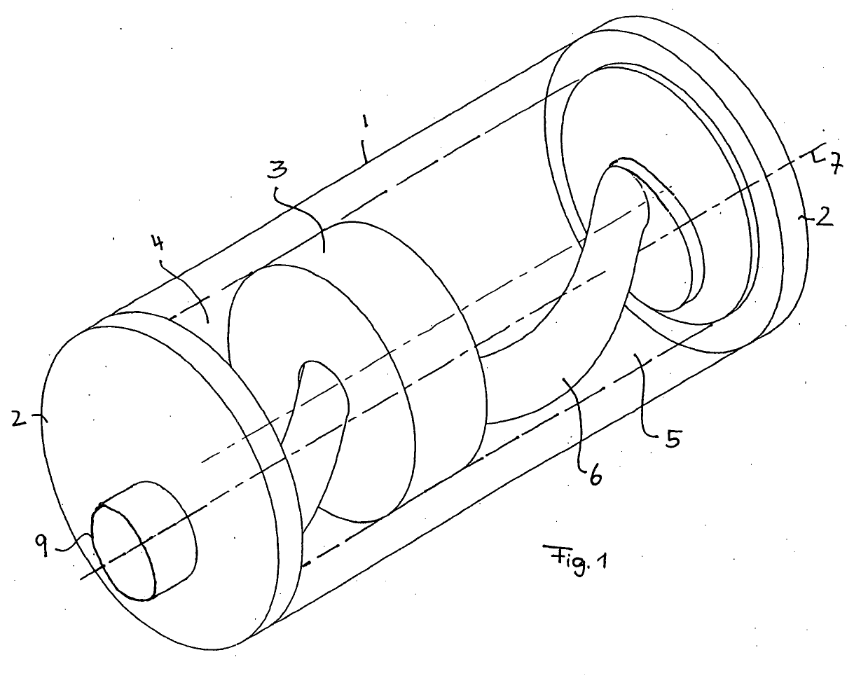

FIG. 1 a schematic spatial representation of a rotary motor with a helically curved drive shaft in accordance with a preferred embodiment of the invention;

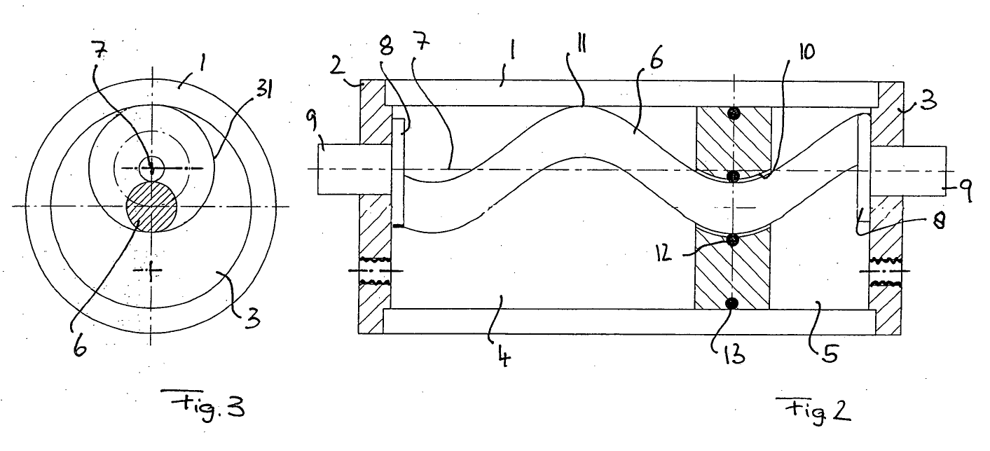

FIG. 2: a longitudinal section through the rotary motor of FIG. 1;

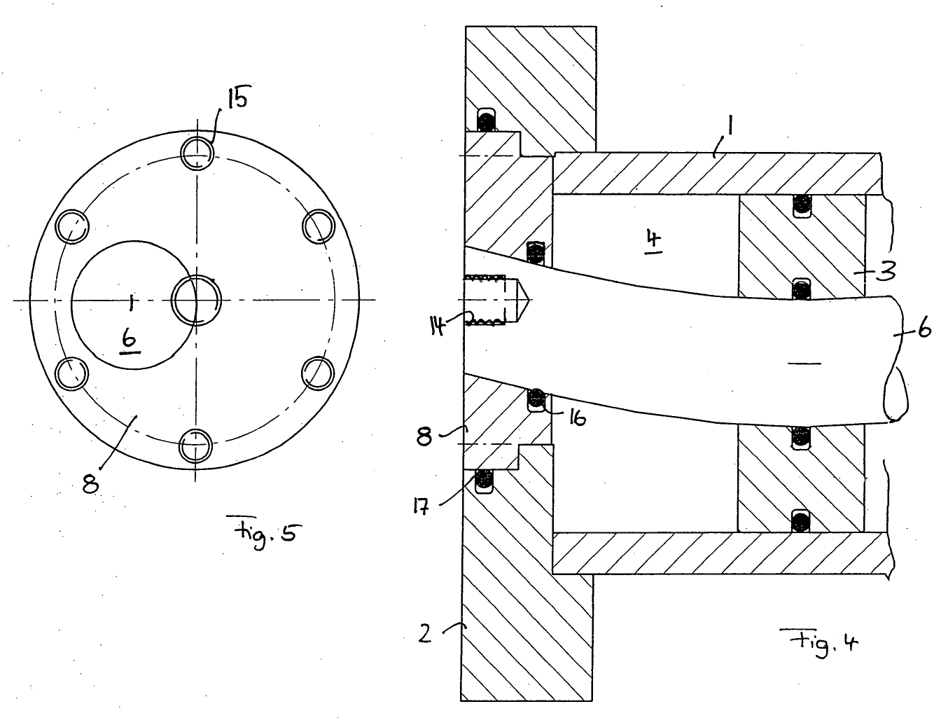

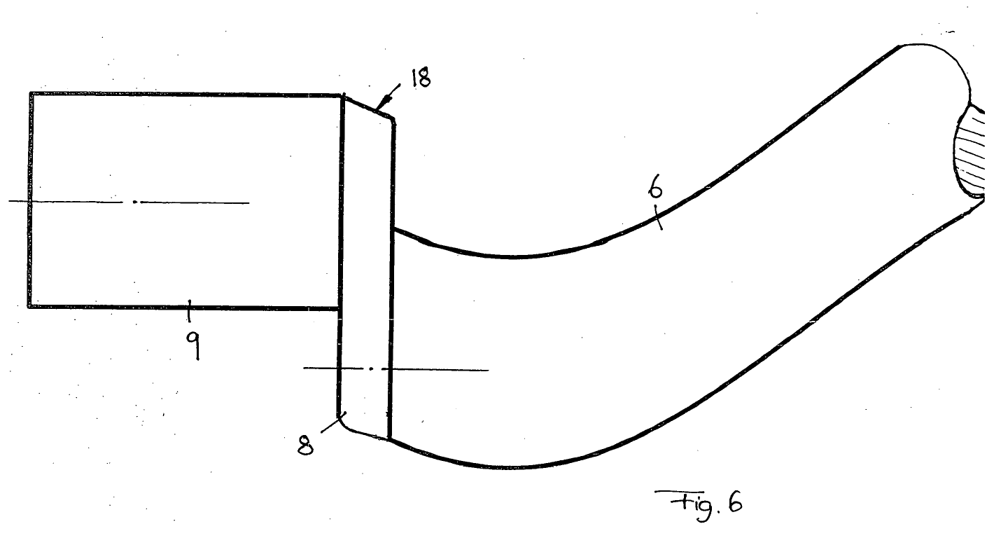

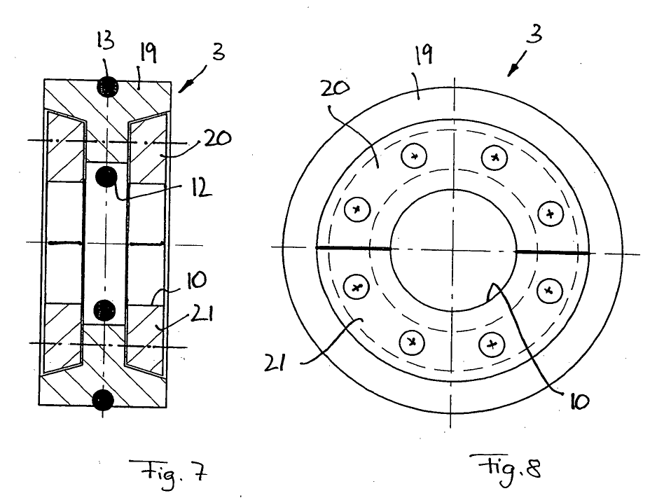

FIG. 3 a cross-section through the rotary motor from the preceding Figures which also shows the envelope of the shaft;

FIG. 4 a partial longitudinal section through the support section of the drive shaft which shows a shaft support in accordance with an alternative embodiment of the invention with an enlarged support disk for an improved load output at the end face;

FIG. 5 a plan view of the bearing disk of FIG. 4 which shows the position of the shaft passage;

FIG. 6 a partial representation of a drive shaft in accordance with an alternative embodiment of the invention, wherein a drive shaft journal is connected integrally to the drive shaft in one piece;

FIG. 7 a sectional view of a piston made in multiple parts in accordance with a preferred embodiment of the invention, according to which two respective piston half-shells are placed at both sides at the end face on a ring-shaped piston carrier;

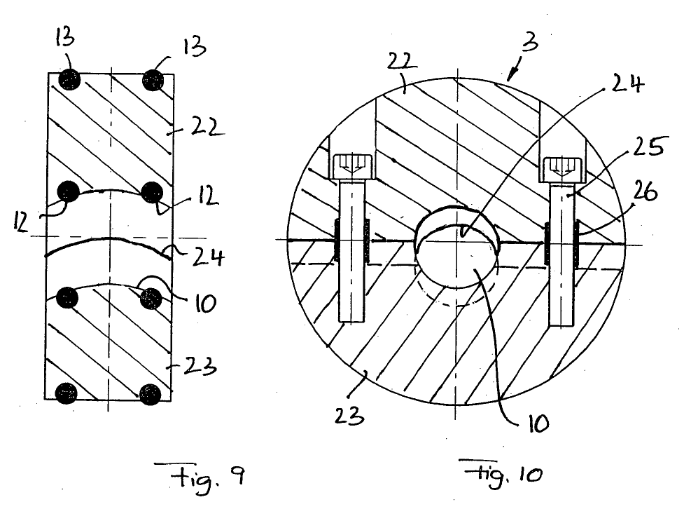

FIG. 8 an end-face plan view of the piston of FIG. 7;

FIG. 9 a sectional representation of a piston composed of two half-shells in accordance with an alternative embodiment of the invention, wherein the joint is curved in accordance with the curvature of the drive shaft;

FIG. 10 a cross-section through the piston of FIG. 9 which shows the screw connection of the two piston half-shells;

FIG. 11 a sectional view of a single-part piston in accordance with a further preferred embodiment of the invention with a double seal and hydraulic pressure compensation;

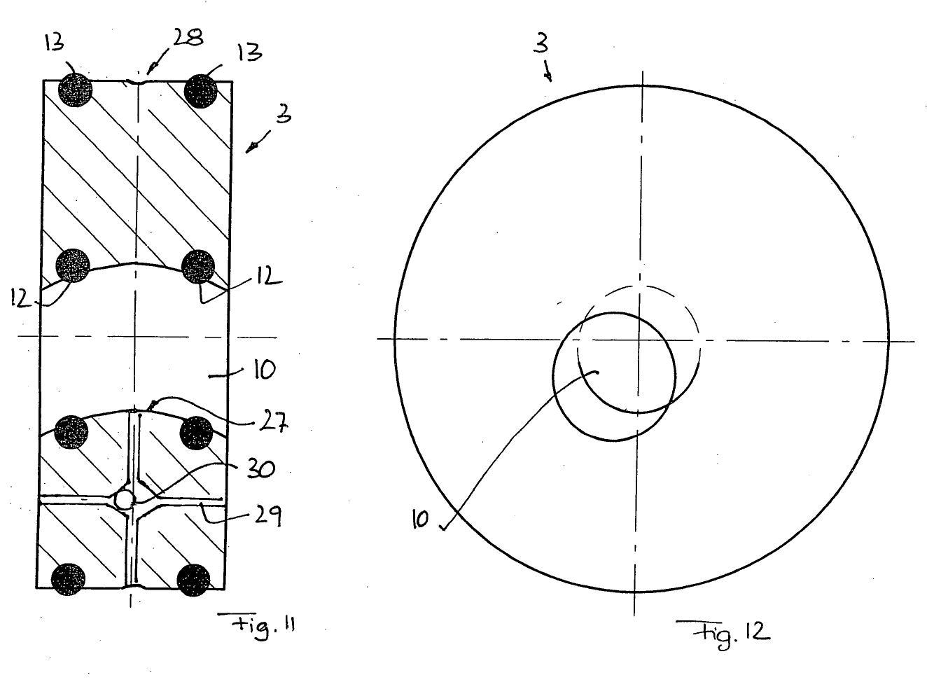

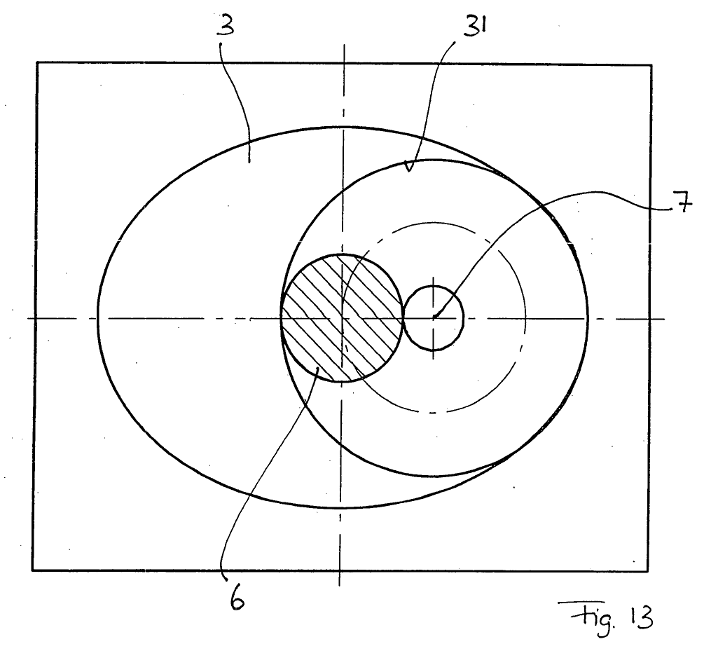

FIG. 12 an end-face plan view of the piston of FIG. 11;

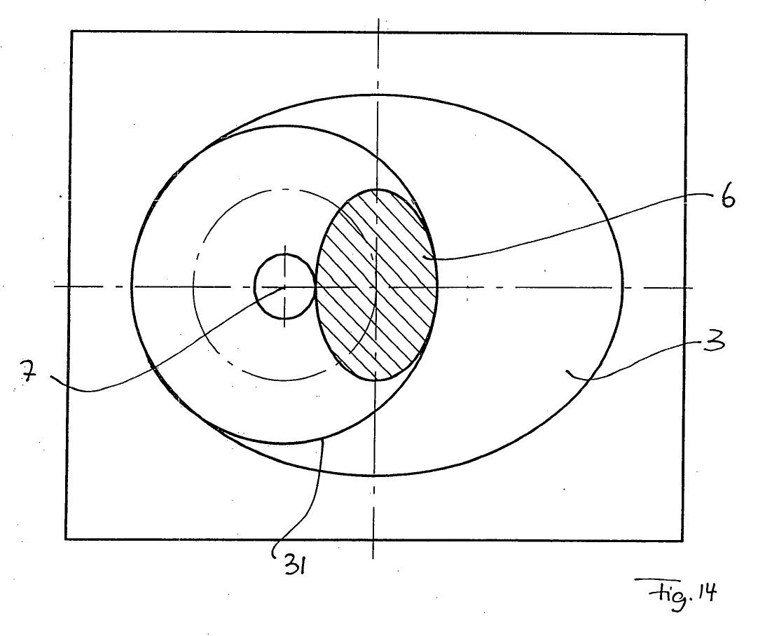

FIG. 13 an end-face view of a piston of oval shape in accordance with a further embodiment of the invention, with the drive shaft being show in section and with its envelope;

FIG. 14 an end-face view of an oval piston, similar to FIG. 13 wherein the drive shaft also has an oval cross-section, however.

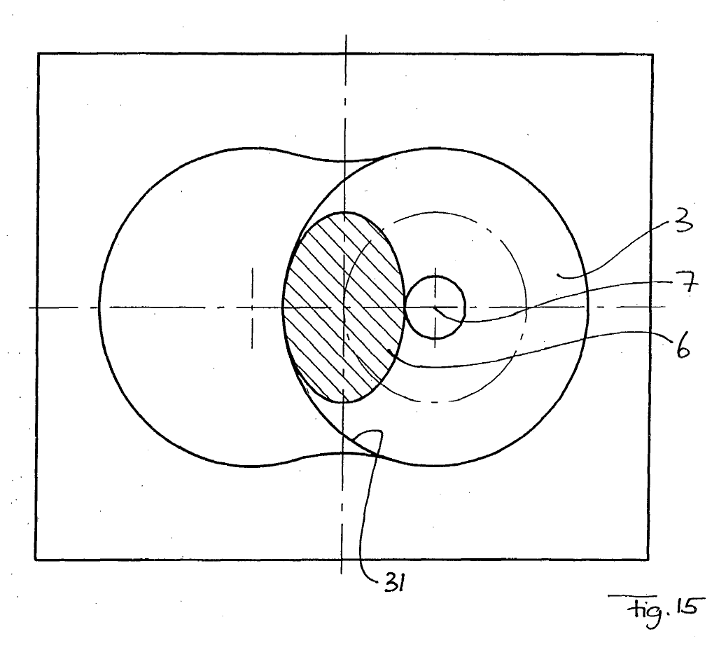

FIG. 15 an end-face view of a piston with an oval shape having a central restriction in accordance with a further preferred embodiment of the invention by which an improved support of the drive shaft can be achieved;

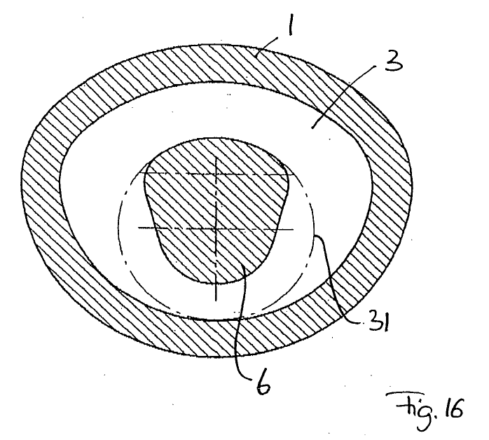

FIG. 16 a sectional view through a rotary motor with an egg-shaped, polygonal cross-section of the drive shaft and a likewise polygonal piston, which are optimized with respect to torsional stiffness of the shaft and to the balance of forces at the piston.

FIG. 17 a partial sectional view of the support region of the drive shaft similar to FIG. 4 in accordance with a further preferred embodiment of the invention, wherein a control slide fastened to the support disk is provided for the end position damping and/or continuous setting of the end position.

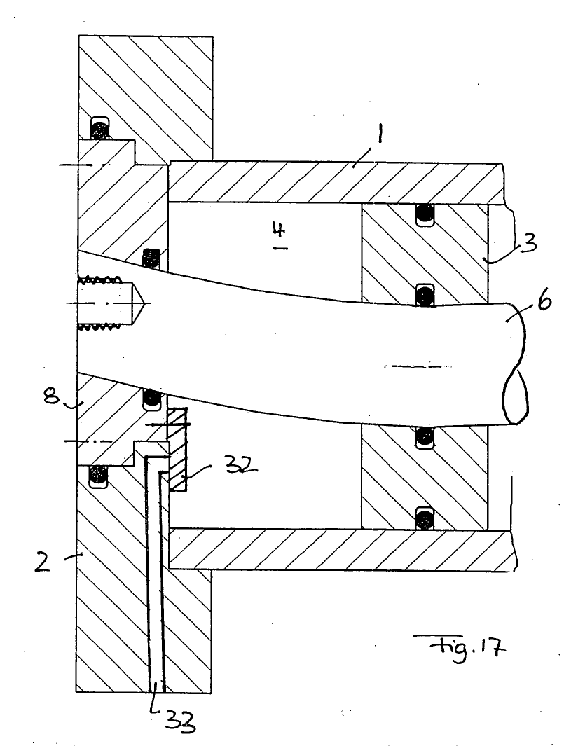

FIG. 18 a schematic representation of two rotary motors which are hydraulically synchronized with one another in accordance with a preferred embodiment of the invention;

FIG. 19 a longitudinal sectional view of a rotary motor in accordance with a further preferred embodiment of the invention, wherein two drive shafts are arranged in a common housing and can be driven by a common axial adjustment piston.

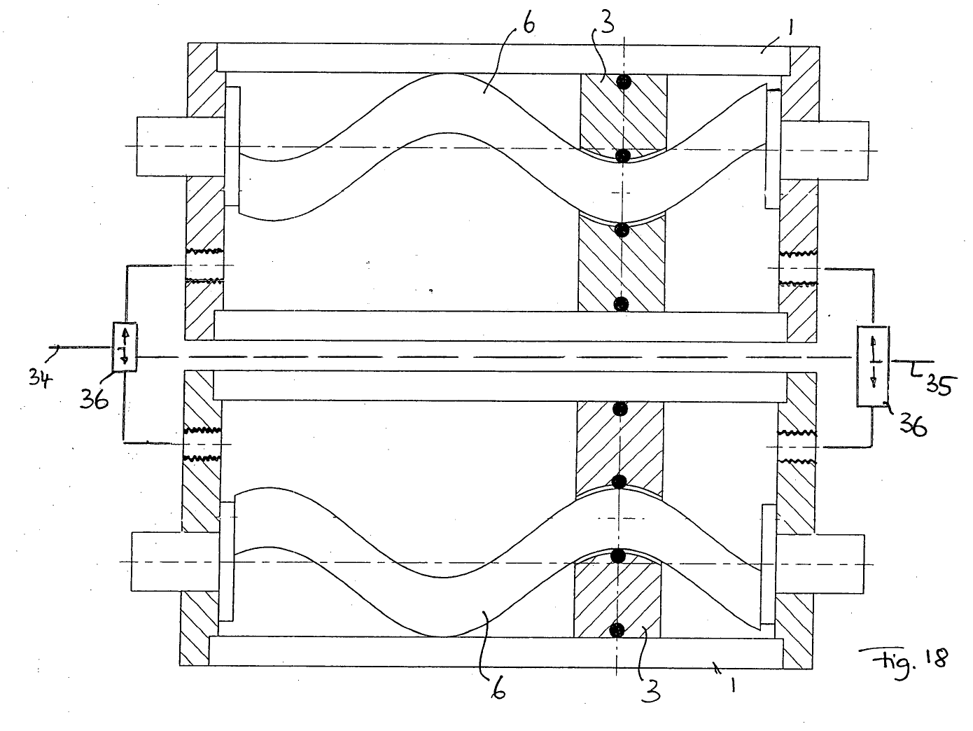

FIG. 20 a cross-sectional view of the rotary motor of FIG. 19 which shows a??? common piston as well as the two shafts engaged therewith in a sectional manner;

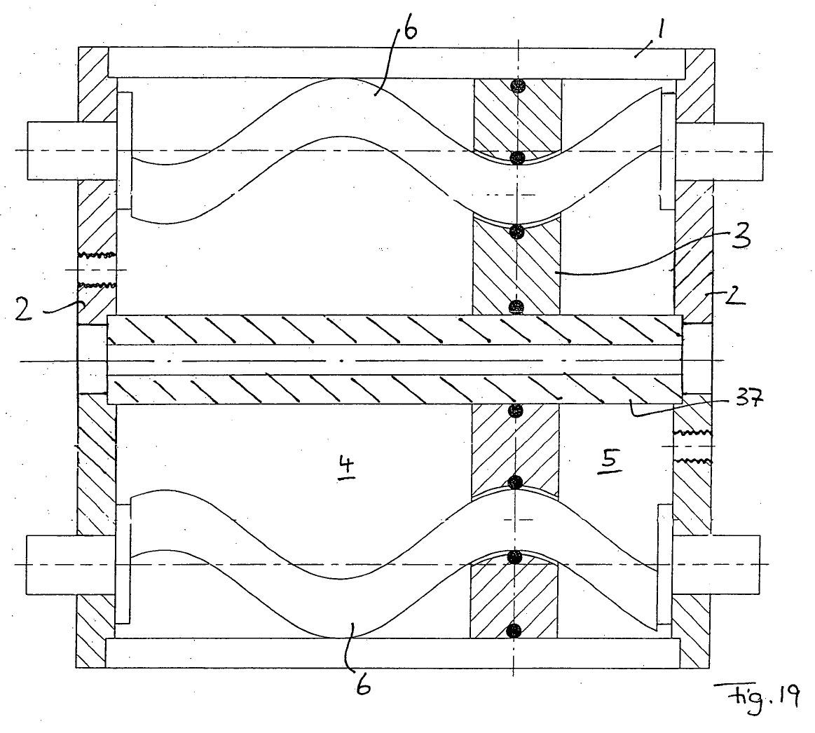

FIG. 21 a longitudinal section through a rotary motor in accordance with a further embodiment of the invention, wherein the drive shaft made as crankshaft has a straight crank section, whereas the piston is longitudinally displaceable guided in a spirally rotated housing pipe;

FIG. 22 a cross-sectional view of the rotary motor of FIG. 21 which shows the housing wall and the shaft in section;

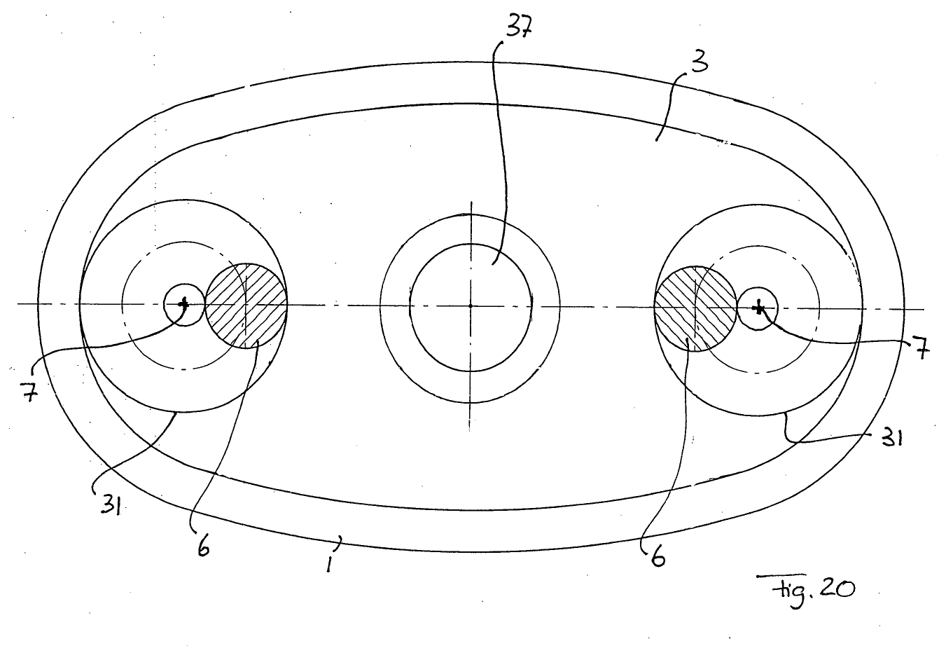

FIG. 23 a sectional longitudinally sectioned representation of a rotary motor in accordance with a preferred embodiment of the invention which as an output gear which is integrated in the housing or the end-face housing cover;

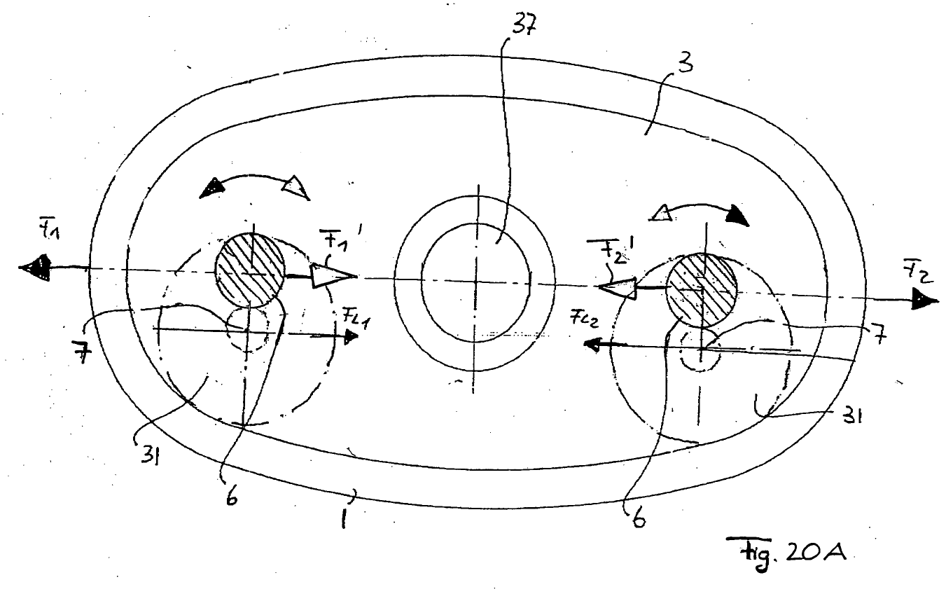

FIG. 24 a longitudinal section through a rotary motor in accordance with a preferred embodiment of the invention, wherein the helically curved drive shaft is supported in the manner of a ball joint at its ends;

FIG. 25 a cross-section through the rotary motor of FIG. 24,

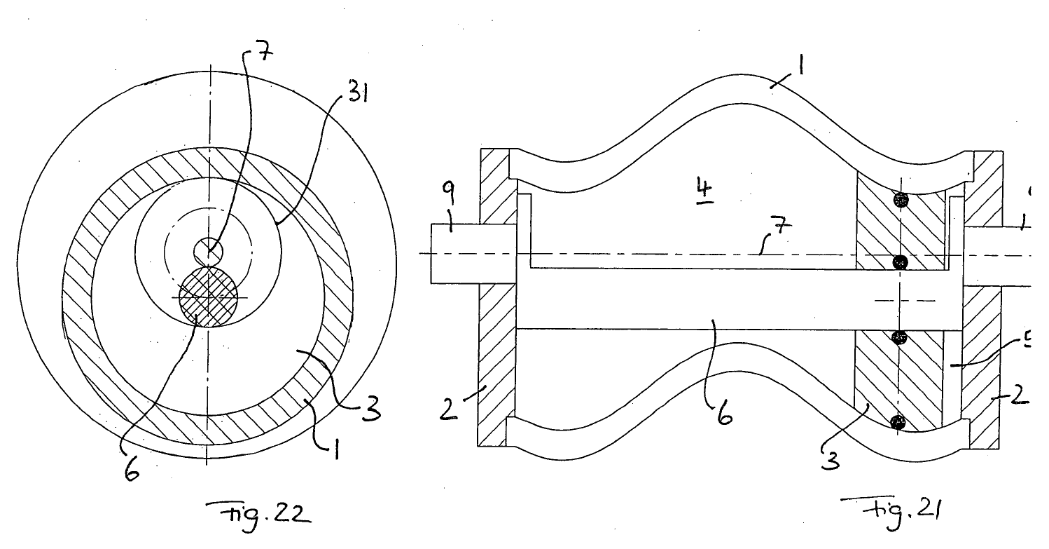

FIG. 26 a longitudinal section through a single-part piston with divided pressure pockets;

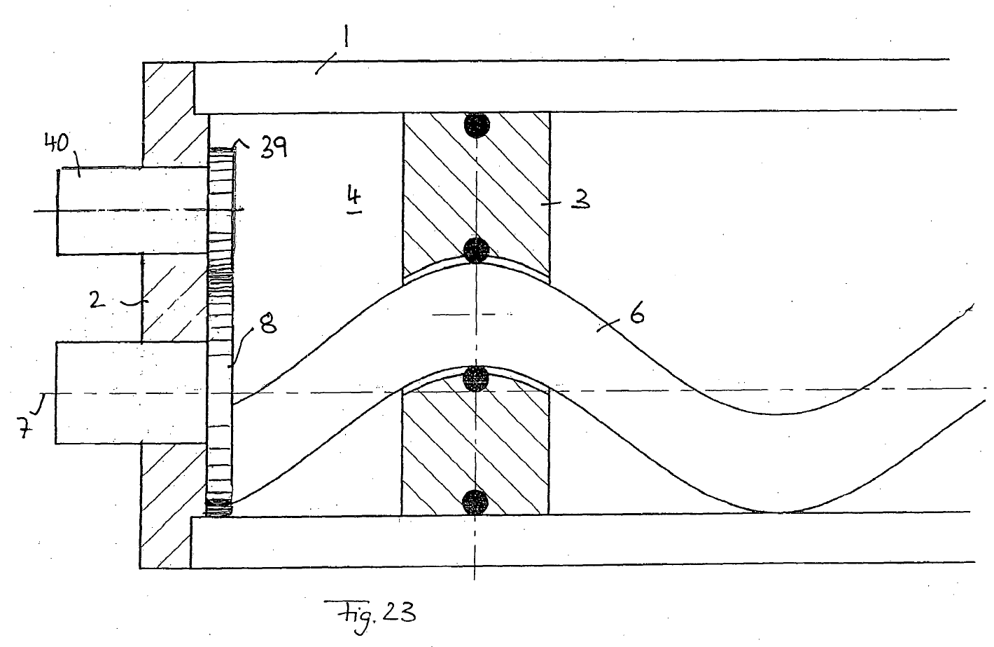

FIG. 27 an end-face plan view of the piston of FIG. 26;

FIG. 28 a longitudinal section through a single-part piston with divided pressure pockets which are generated by a peripheral sealing in S shape;

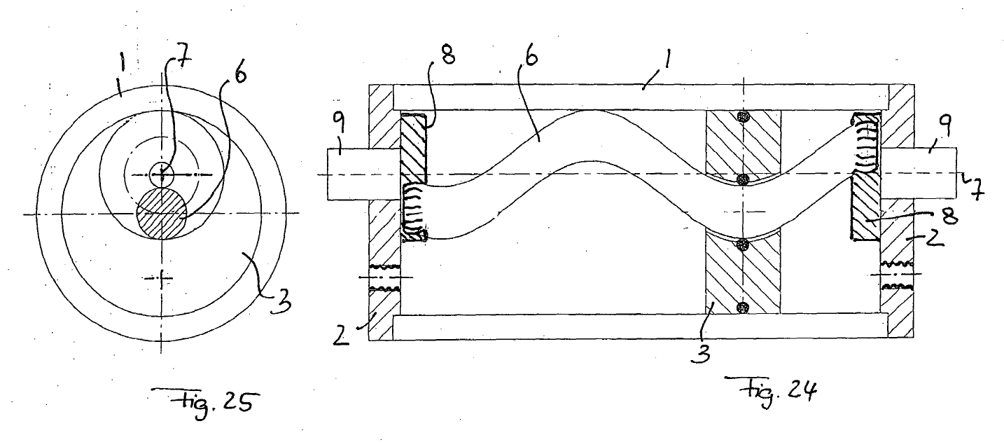

FIG. 29 an end-face plan view of the piston of FIG. 28;

FIG. 30 a longitudinal section through a rotary motor in accordance with a further preferred embodiment of the invention, wherein a diagonal seal is provided between the piston and the housing and/or between the shaft and piston and the shaft is provided with output shaft pins shaped inside its inner envelope section;

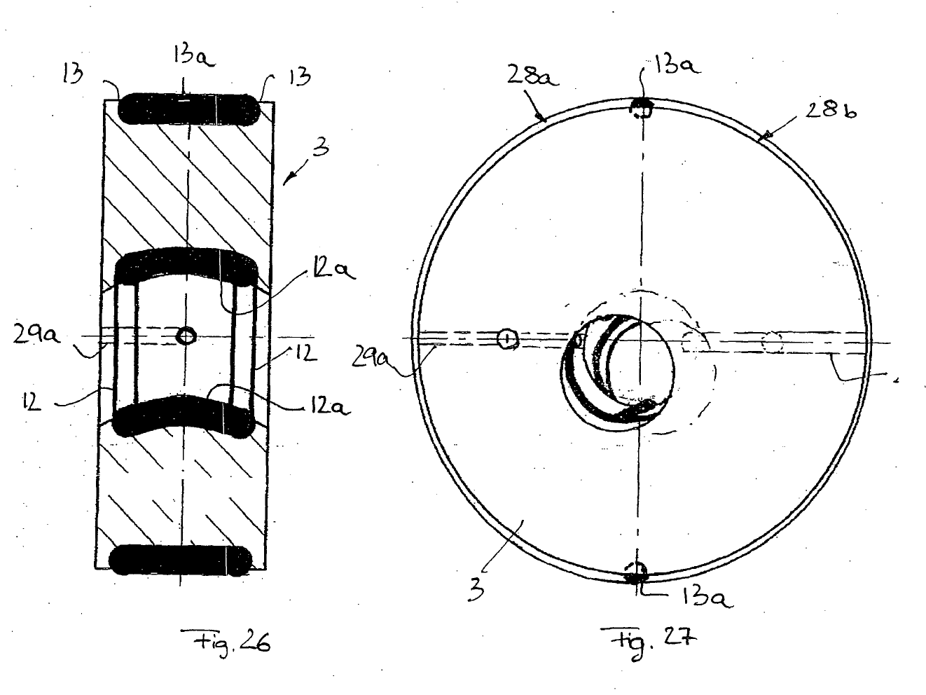

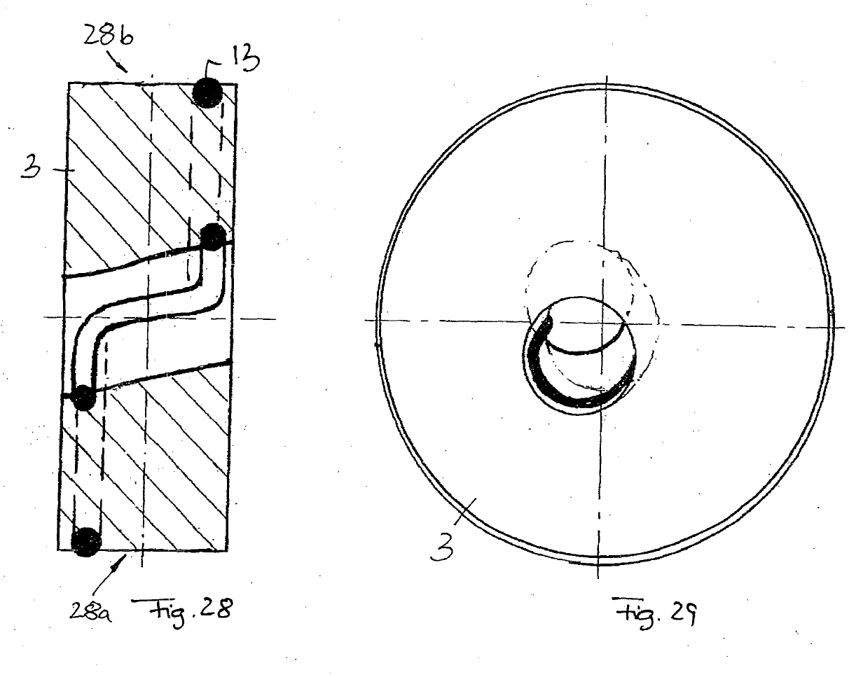

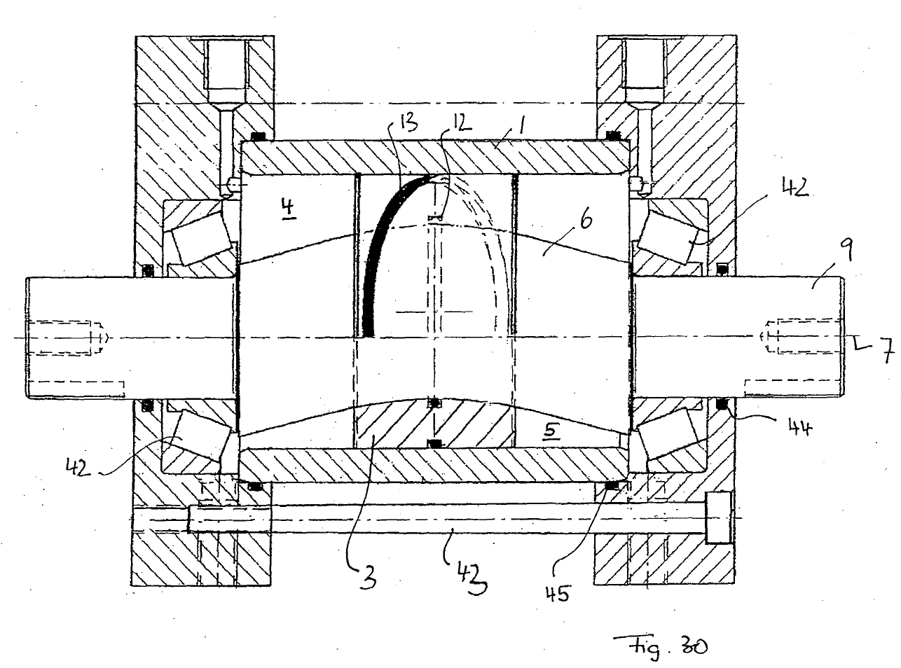

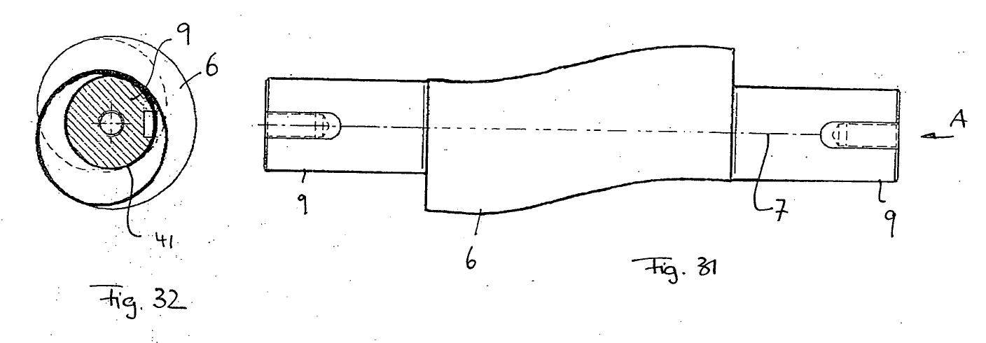

FIG. 31 a side view of the shaft of the rotary motor of FIG. 30;

FIG. 32 an end-face view of the shaft of FIG. 31 in the line of sight of the arrow A drawn in FIG. 31;

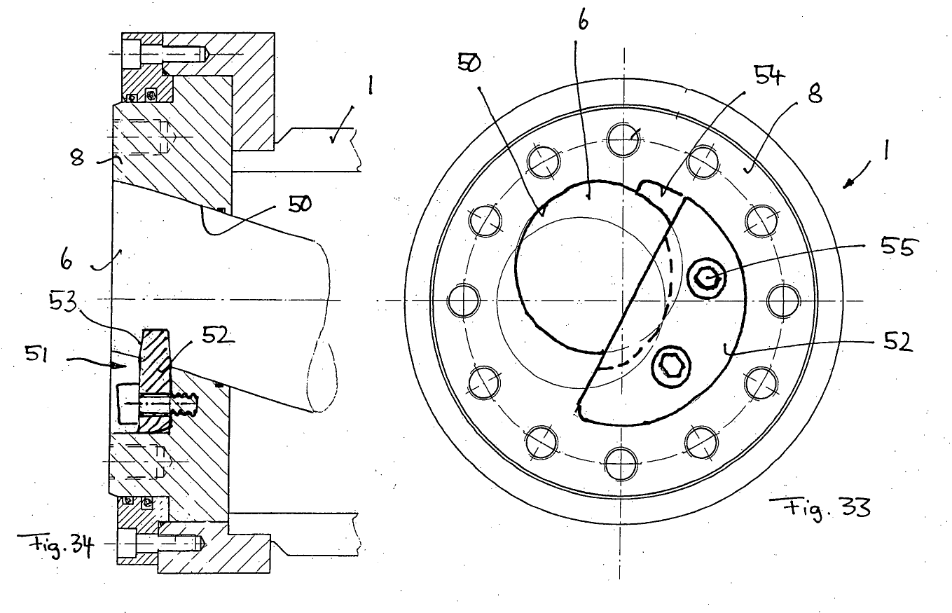

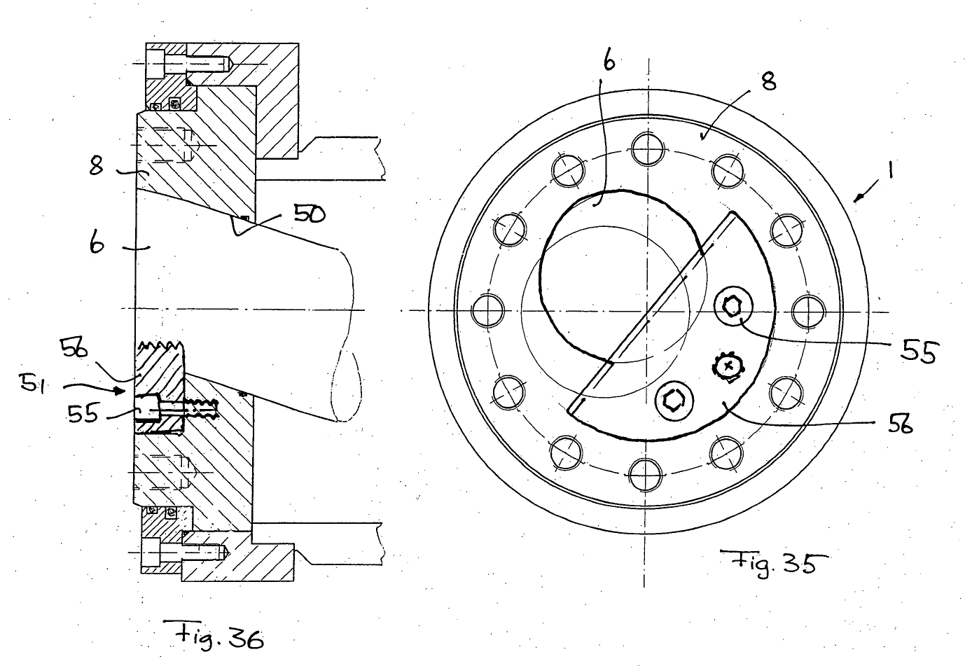

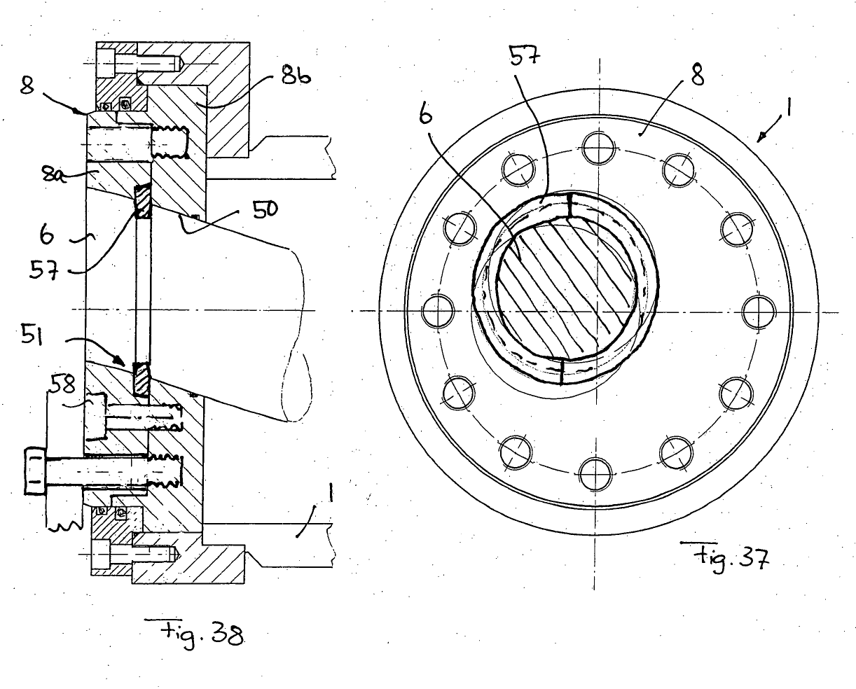

FIG. 33 an end-face view of a shaft fastening at a support plate in accordance with a preferred embodiment of the invention with a shape matched element in the shape of a push-plate;

FIG. 34 a sectional view of the shaft fastening at the support plate of FIG. 33;

FIG. 35 an end-face view of a shaft fastening at a support plate in accordance with a preferred embodiment of the invention with a shape matched element in the shape of a toothed-plate;

FIG. 36 a sectional view of the shaft fastening at the support plate of FIG. 35;

FIG. 37 an end-face view of a shaft fastening at a two-part support plate in accordance with a preferred embodiment of the invention with a shape matched element in the shape of a push-support ring;

FIG. 38 a sectional view of the shaft fastening at the support plate of FIG. 37;

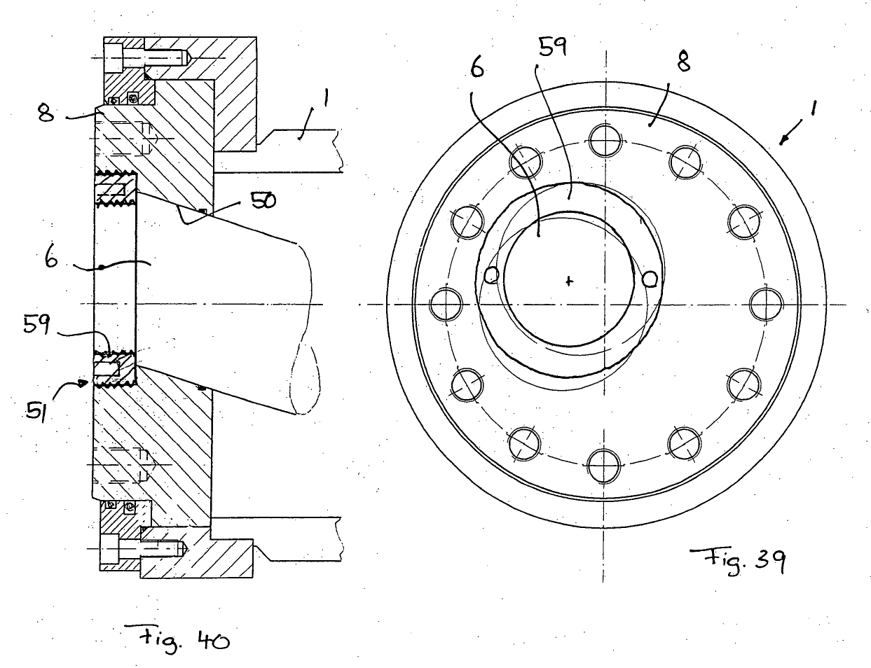

FIG. 39 an end-face view of a shaft fastening at a support plate in accordance with a further preferred embodiment of the invention with a shape matched element in the shape of a push-nut;

FIG. 40 a sectional view of the shaft fastening at the support plate of FIG. 39;

FIG. 41 an end-face view of a shaft fastening at a support plate in accordance with a further preferred embodiment of the invention with a shape matched element in the shape of a push-nut;

FIG. 42 a sectional view of the shaft fastening at the support plate of FIG. 41;

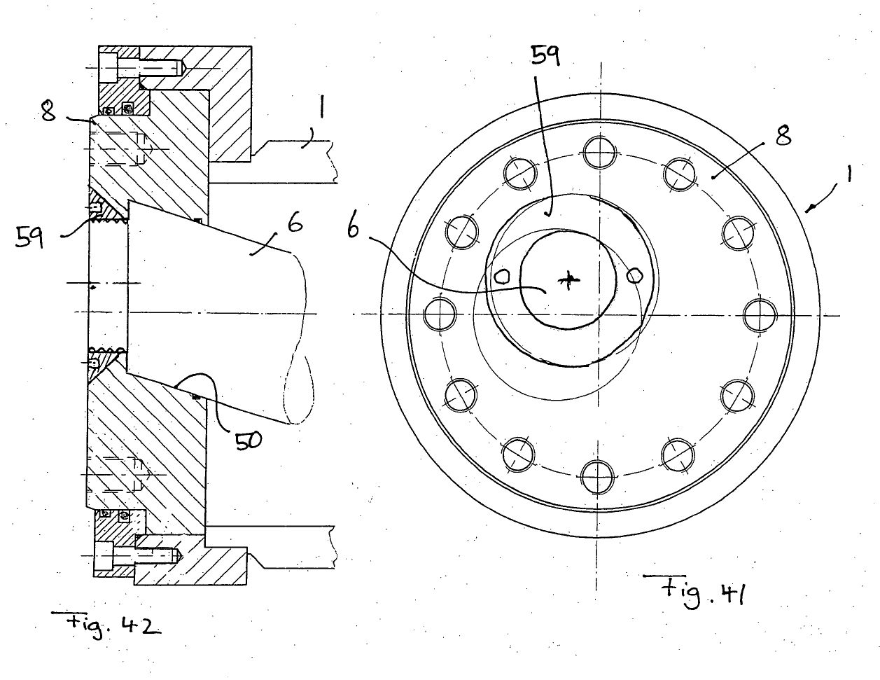

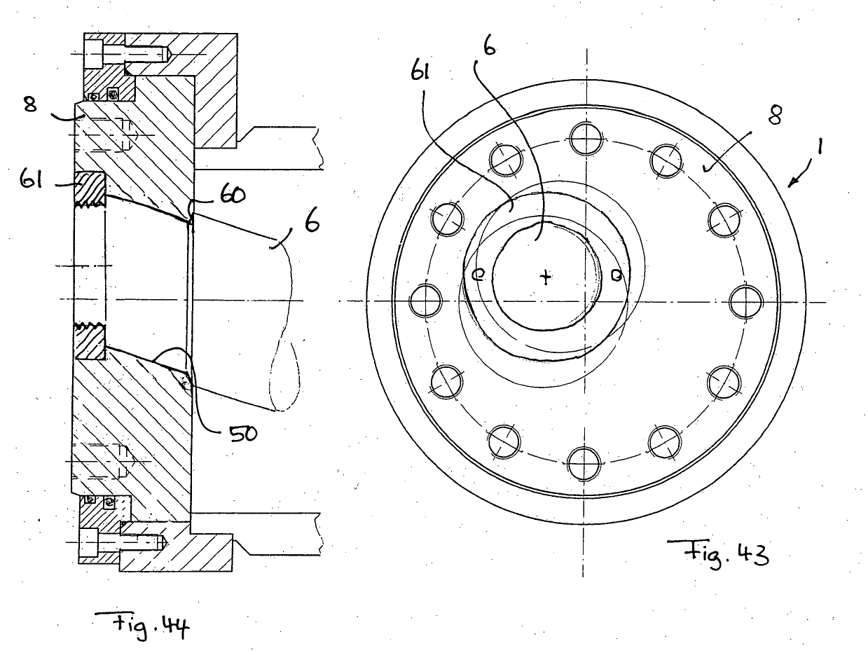

FIG. 43 an end-face view of a shaft fastening at a support plate in accordance with a further preferred embodiment of the invention with a shape matched element in the shape of a push-nut as well as a step at the shaft;

FIG. 44 a sectional view of the shaft fastening at the support plate of FIG. 43;

FIG. 45 an end-face view of a shaft fastening at a support plate in accordance with a preferred embodiment of the invention with a shape matched element in the shape of a slot push-plate;

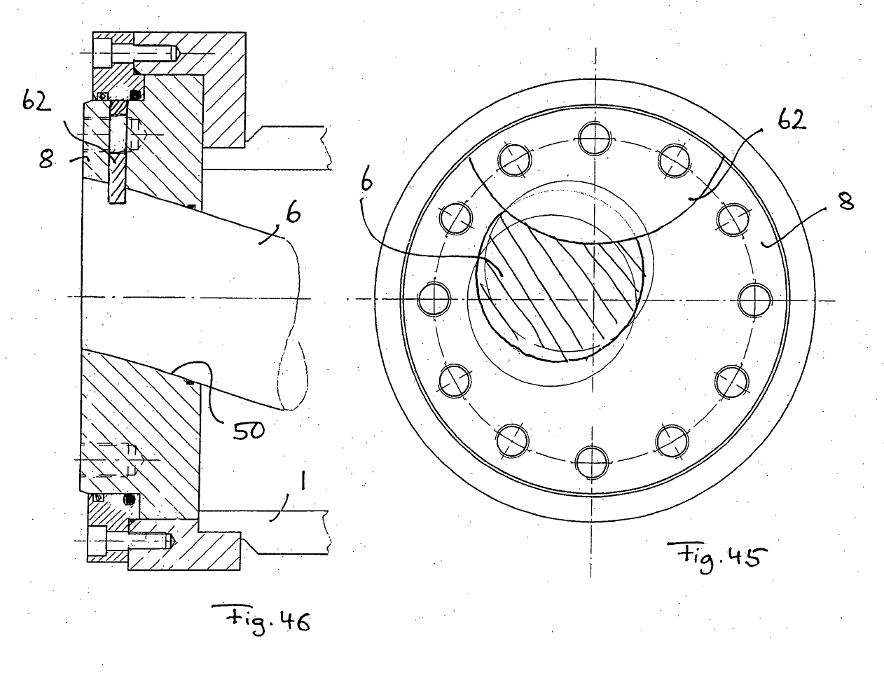

FIG. 46 a sectional view of the shaft fastening at the support plate of FIG. 45;

FIG. 47 an end-face view of a shaft fastening at a support plate in accordance with a preferred embodiment of the invention with a shape matched element in the shape of an inwardly disposed slot push-plate;

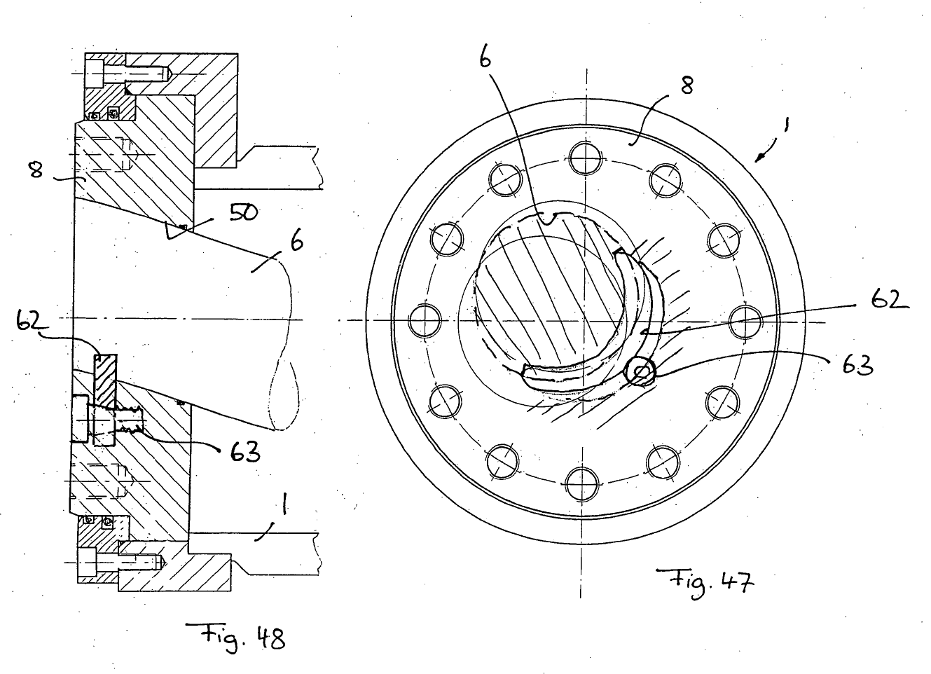

FIG. 48 a sectional view of the shaft fastening at the support plate of FIG. 47;

FIG. 49 an end-face view of a shaft fastening at a support plate in accordance with a further preferred embodiment of the invention with an expansion cone spreading the shaft apart;

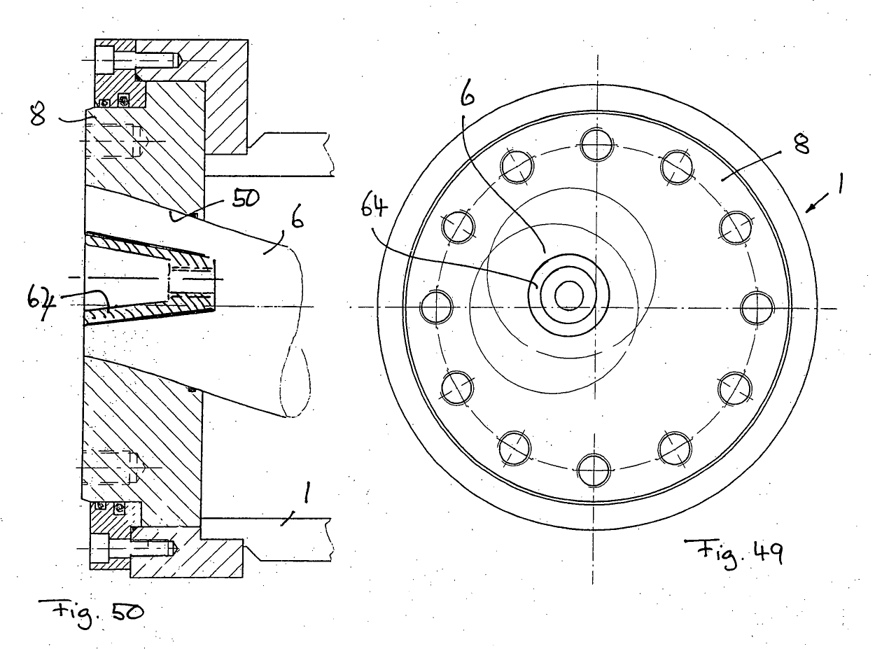

FIG. 50 a sectional view of the shaft fastening at the support plate of FIG. 49;

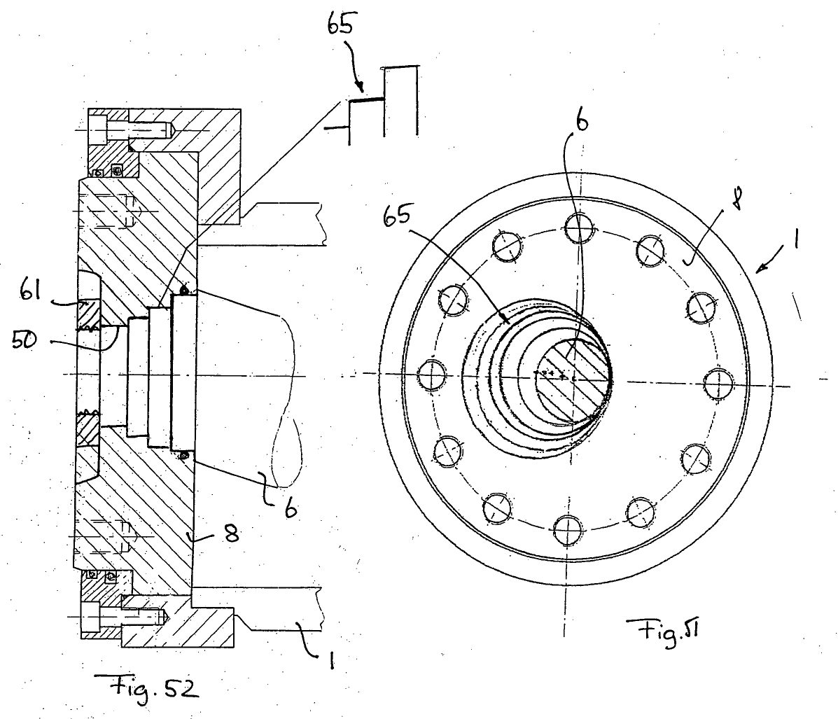

FIG. 51 an end-face view of a shaft fastening at a support plate in accordance with a further preferred embodiment of the invention with a stepped shaft end which is seated in a stepped support plate cut-out;

FIG. 52 a sectional view of the shaft fastening at the support plate of FIG. 51;

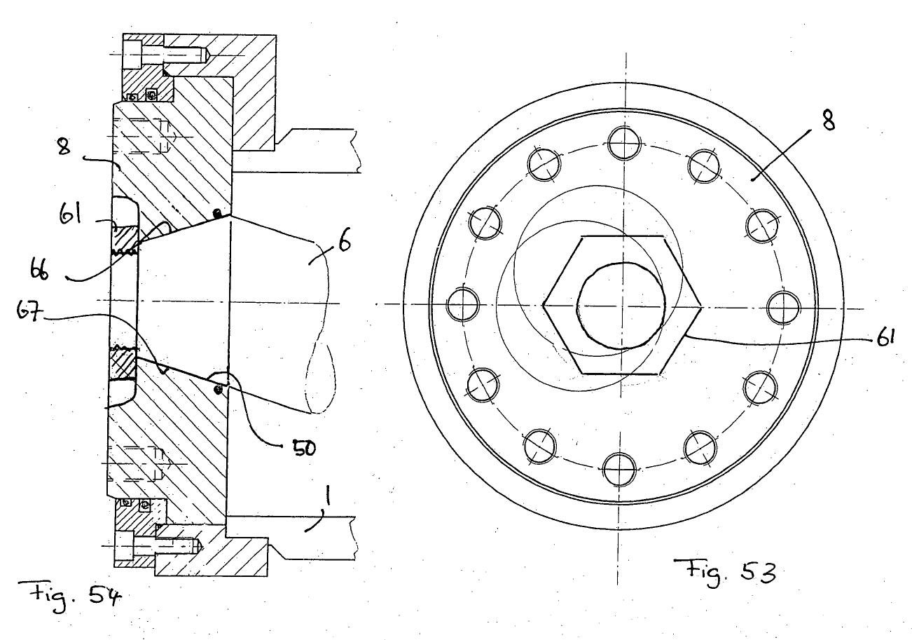

FIG. 53 an end-face view of a shaft fastening at a support plate in accordance with a further preferred embodiment of the invention with an eccentrically chamfered shaft end which is seated in a complementary support plate cut-out;

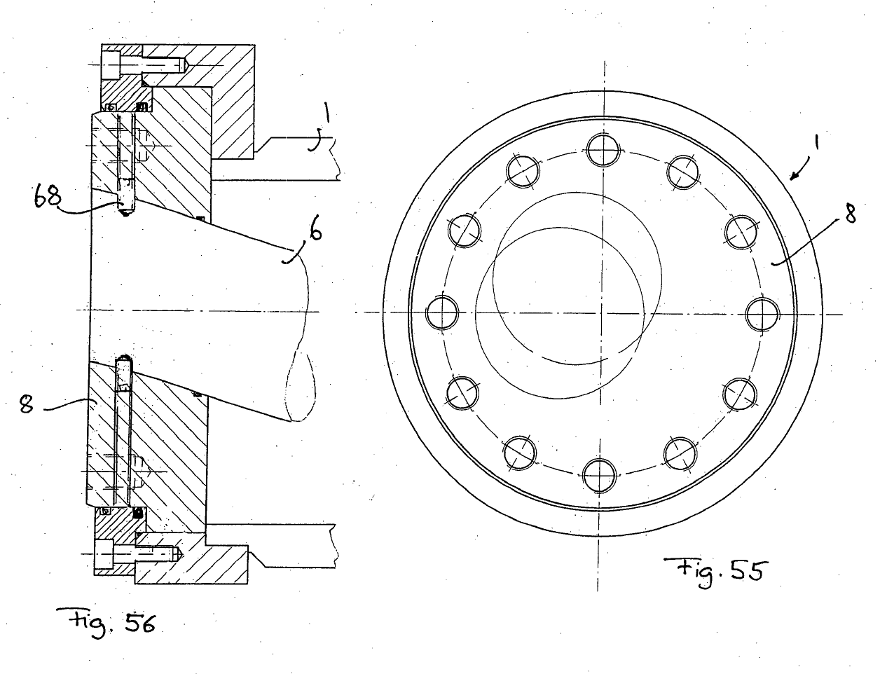

FIG. 54 a sectional view of the shaft fastening at the support plate of FIG. 53;

FIG. 55 an end-face view of a shaft fastening at a support plate in accordance with a preferred embodiment of the invention with shape matched elements in the shape of radial threaded pins;

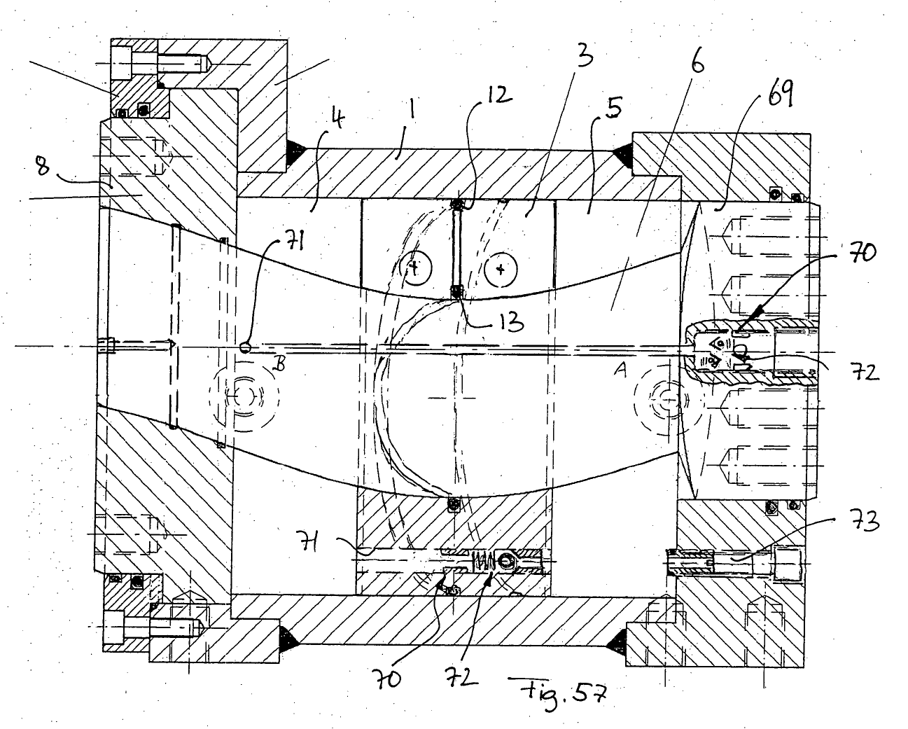

FIG. 56 a sectional view of the shaft fastening at the support plate of FIG. 55; and

FIG. 57 a schematic longitudinal section through a rotary motor in accordance with a preferred embodiment of the invention, wherein the shaft is supported differently at its ends and can be axially removed from the motor housing together with the piston.

The rotary motor shown in FIGS. 1 to 3 includes a tubular cylindrical housing 1 which is closed in each case by a support cover 2 at its two end faces. The housing 1 can be made from an endless section which was cut to size to the desired length. A piston 3 is axially displaceably received in the inner space of the housing 1 and divides the inner space of the housing 1 into two pressure chambers 4 and 5 which can be charged with pressure medium via pressure medium lines in the support covers 2 in the drawn embodiment so that the piston 3 moves axially to and fro in the housing 1 in dependence on which of the two chambers 4 or 5 is charged with pressure medium.

A drive shaft 6 is furthermore received in the housing 1 and is rotatably supported at both support covers 2 in the embodiment drawn so that it can be rotated around an axis of rotation 7 parallel to the longitudinal axis of the cylindrical housing 1. As FIG. 1 and FIG. 2 show, the drive shaft 6 in the embodiment drawn is rotated spirally around the named axis of rotation 7, with the drive shaft 6 having an eccentricity with respect to the named axis of rotation 7 which gives the respective engagement section of the shaft with the piston a lever arm with respect to the axis of rotation 7. The drive shaft 6 so-to-say screws itself around the axis of rotation 7 and actuates the lever arm via the wedge effect of the pitch. The drive shaft 6 in the embodiment drawn in FIGS. 1 to 3 is circular in cross-section. It can consist of an endless section which was cut to size to the desired length. At the end-face side, it is respectively fastened to a support plate 8 at which in turn an output shaft extending through the support cover 2 is rotationally fixedly fastened in the form of a shaft stump 9.

As FIG. 2 shows, the piston 3 has a shaft passage cut-out 10 with which the piston 3 is longitudinally displaceably seated on the drive shaft 6, with the piston undergoing a rotation on the displacement on the shaft in accordance with its preferably helical shaft passage cut-out. The shaft passage cut-out 10 is, like the drive shaft 6, circular in its cross-section, with the shaft passage cut-out 10, considered in the axial direction, being adapted to the curved extent of the drive shaft 6 and having a curved extent coinciding with the shaft.

The geometrical relationships and the arrangement of the drive shaft 6 are advantageously selected such that the shaft passage cut-out 10 is seated substantially centrally in the cross-sectional center of area of the piston 3 so that the piston 3 is balanced with respect to the forces induced by the drive shaft 6 and in particular no moments of tilt occur. For this purpose, the axis of rotation 7 of the drive shaft 6 is radially offset with respect to the longitudinal central axis of the housing 1 and of the piston 3, and indeed advantageously as much as possible so that a section of the drive shaft 6 disposed as centrally as possible between its two ends, or also a plurality of sections of the drive shaft depending on the pitch, abuts or abut the inner jacket surface of the housing 1 or is or are supported thereon. This point is marked by the reference numeral 11 in FIG. 2. It is understood that this point migrates on rotation of the drive shaft 6. With a cylinder liner circular in cross-section as well as a shaft likewise circular in cross-section, the eccentric amount of the shaft which determines the efficiency of the motor, i.e. the shaft jump, can correspond to approximately a quarter of the difference of cylinder diameter and shaft diameter, that is ε=¼(d_{z}−d_{w}). The best possible efficiency of the motor can hereby be achieved with a compact and simple design.

The surface pairs which effect the force transmission between the drive shaft 6 and the piston 3 or between the piston 3 and the housing 1, that is the jacket surface of the drive shaft 6 and the inner jacket surface of the shaft passage recess 10, on the one hand, and the outer jacket surface of the piston and the inner jacket surface of the housing, on the other hand, advantageously form sealing surface pairs which seal the pressure chambers 4 and 5. Seals 12 and 13 are advantageously integrated into these surface pairs to avoid pressure losses. In this respect, the shaft seal 12 is seated in the drawn embodiment in the shaft passage cut-out 10 and slides off the outer jacket surface of the drive shaft 6. The housing seal 13 is seated on the outer jacket surface of the piston and seals the piston 3 with respect to the housing 1 on which the named seal 13 slides off. Both seals are made as sealing rings in the embodiment drawn.

If one of the pressure chambers 4 or 5 is charged with pressure medium, the piston 3 migrates axially. This axial setting movement results in a rotation of the drive shaft 6 around the axis of rotation 7 since the helical section of the drive shaft 6 respectively sliding through the shaft passage cut-out 10 has a corresponding lever arm with respect to the axis of rotation 7 and the pitch of the drive shaft 6 exerts a wedge effect which translates the axial setting force of the piston 3 into a radial force actuating the lever arm. The drive shaft 6 is driven in accordance with the crank principle by the axial adjustment movement of the piston 3. Since the shaft passage cut-out 10 is seated at the center of the piston 3, the forces transmitted to the piston by the drive shaft 6 approximately have no lever arm so that these forces do not effect any torque onto the piston. The piston 3 does not have to be guided in a manner secure against rotation in the housing 1. This has an advantageous effect on the seals 12 and 13.

The embodiment shown in FIGS. 1 to 2 provides considerable advantages. The required installation length is first cut by the direct guidance of the drive shaft 6 in the shaft passage cut-out 10 and of the piston 3 in the housing 1 with an integrated sealing in each case and a large torque can be generated by a small steepness of the helical extent of the drive shaft 6. Radial forces are substantially introduced into the piston 3 and via this into the housing 1. The production effort can be substantially reduced both for the outer guidance of the piston and for the inner guidance of the piston with respect to the shaft over the conventional solutions with a steep toothed arrangement or a steep thread toothed arrangement. In a typical ideal case, shapes and components are used which are very easy to manufacture, which are manufactured endlessly and which can be tailored to the actual requirement and length. The lever length and the pitch of the helical drive shaft 6 can be fixed practically as desired by the load engagement at the helix center. A low pitch and a large lever arm generate high torques. In addition, the piston surface can be used effectively, with equal forces being able to be achieved in both directions. The total inner cross-sectional surface of the housing less the shaft cross-sectional surface is substantially available as the effective piston surface. Furthermore, due to the small surface pressing, pressure media which are free of or low in lubricants such as water or air can be used.

Some of the axial load output can advantageously take place via the support plate 8 by means of which the drive shaft 6 is supported at the end face at the housing end, in particular when a large-area support plate 8 is used, as FIG. 4 shows. The drive shaft 6 extends in this respect in its helical shape and pitch into the support plate 8 and transmits the torque to the support plate over the full area thanks to its spiral shape, with it being able to be secured only by means of an axial and/or radial security, e.g. in the form of screw connection 14, against being pulled out. If, for example, the pressure chamber 4, which is shown in FIG. 4, is charged with pressure medium, the latter presses the piston 3 to the right, whereby an axial force is transmitted to the drive shaft 6 which attempts to pull the drive shaft 6 to the right in accordance with FIG. 4. The same pressure in the pressure chamber 4, however, also acts on the support plate 8 which partially compensates this axial force. As FIG. 5 shows, the support plate 8 can output the torque over a plurality of screw connections 15, with the sealing of the pressure chamber 4 being ensured via seals 16 and 17.

FIG. 6 shows the drive shaft 6 with a directly attached or connected output shaft 9 in the form of a shaft stump. The diameter of the output shaft stump 9 and the width of the support plate 8 is advantageously not larger than the diameter of the output shaft 6 itself so that a shaft seal 12 can be pushed onto the drive shaft 6 over the drive shaft stump 9 for the sealing of the piston 3 with respect to the shaft 6. This is advantageously supported by a chamfered section 18 of the support plate 8. The total drive shaft 6 together with the attached output shaft stump 9 is made such that a resilient sealing ring having an inner diameter corresponding to the outer diameter of the drive shaft 6 can be pushed over the total shaft assembly.

One of the ends of the drive shaft 6 is, however, advantageously connected, preferably releasably, to a separately formed support plate 8, as FIG. 33 ff. show. The support of the drive shaft 6 via a separate support plate 8 allows very high axial forces and transverse forces with superimposed torques to be output without having to accept an excessive production effort.

It is particularly preferred in this respect if there is a connection in the manner of a helix-in-helix between the support plate and the drive shaft, i.e. the spiral or helical extent of the drive shaft 6 is seated in a likewise spiral or helical cut-out 50 in the support plate 8. In this respect, the helical shaft section is advantageously fixed axially and/or radially in the helical recess 51 of the support plate with the help of a shape matched element 51 and is optionally tensioned or anchored, whereby the radial play caused by the helix with releasable joints can be eliminated.

As FIGS. 33 and 34 show, the helical contour of the drive shaft 6 can run in a manner unchanged per se into the support plate 8 or the likewise helically contoured cut-out 50 provided therein. The shape matched element 51 is formed in this embodiment by a—simplistically stated—crescent shaped push-plate 52 which engages into a radially extending groove 53 in the drive shaft 6 and is supported at the support plate 8. For installation, the support plate 8 is pushed or turned inwardly on the drive shaft until the push-plate 52 can be placed into the groove 53, whereupon the support plate 8 can be withdrawn. The cut-out provided at the end face in the support plate 8 for the reception of the push-plate 52 can, for this purpose, have the recess 45 which is shown in FIG. 33 and which has over-size in the peripheral direction to allow the turning back. When the fastening screws 55 are tightened, the push-plate 52 spreads between the preferably wedge-shaped groove 53 and the preferably conical recess 54 in the support plate 8, whereby a play-free, biased axial and radial security is provided.

As FIGS. 35 and 36 show, a toothed plate 56 can also be used instead of the push-plate shown in FIG. 33 as a shaped matched element to secure the shaft and the support plate. The toothed plate 56 is toothed at one end and chamfered conically or in wedge shape at the other end to be able to be tilted in. A play-free radial and axial security can be provided by means of fastening screws 55, cf. FIGS. 35 and 36, with advantageously no rotation of the flange being required.

In the embodiment in accordance with FIGS. 37 and 38, a push-support ring 57 is used as the shape matched element 51 to fix the drive shaft 6 in the helical cut-out of the support plate 8. The support plate 8 is in two parts in this respect, with the dividing plane advantageously being disposed outside the fluid guidance. The push-support ring can be made in slotted, resilient form in multiple parts or in one part.

The push-support ring 57 can be made conical and/or chamfered at the inner side and/or at the outer side so that an axial and radial tensioning of the connection is achieved when the two support plate parts are pulled together. Alternatively or additionally, a nominal gap can be present between the two support plate parts with respect to the helical cut-out formed in them so that the two support plate parts are tensioned with respect to the helical contour and are clamped on the drive shaft 6 on the tightening in a line-flush manner of the clamping means connecting them while preventing a relative rotation of the two support plate parts, which can be effected by linear guides, for example in the form of guide pins—preferably by means of guide screws 58.

Alternatively, the drive shaft 6 can also be held in the support plate cut-out 50 by means of a push-nut 59, as shown in FIGS. 39 to 44. In the embodiment in accordance with FIGS. 39 and 40, the push-nut 59 is provided with an external thread and an internal thread so that it can be screwed to the support plate 8 and to the drive shaft 6 to clamp the drive shaft 6 in the support plate cut-out 50. In accordance with FIGS. 41 and 42, the push-nut 59 is only screwed to the drive shaft 6 by means of an internal thread, with the helical contour being stepped in the support plate 8 so that the shoulder of the drive shaft 6, which forms the transition from the helical contour of the drive shaft 6 to its threaded section, can be tensioned against the corresponding shoulder in the support plate cut-out. In addition, the push-nut is supported on the support plate side at a conical push-nut cut-out so that a centering eliminating the radial play is also achieved, cf. FIG. 42.

In the embodiment in accordance with FIGS. 43 and 44, the helical contour of the drive shaft has a taped diameter which can be established in a simple manner and thus has a shoulder 60 by which it can be clamped against the inner side of the support plate 8. A simple clamp nut 61 is advantageously clamped onto the shaft end at the end face which is tensioned against the support plate 8 and thus pulls the shoulder 60 of the drive shaft 6 toward the support plate 8, cf. FIG. 44.

In accordance with FIGS. 45 and 46, the drive shaft 6 can also be fixed in the helical cut-out 50 of the support plate 8 by a slotted push-plate 62 which is inserted from the outside radially into a slot in the support plate 8 until it engages into a peripherally provided groove at the drive shaft 6, cf. FIG. 46. The slotted push-plate 62 can in particular be approximately lenticular—simplistically stated—in this respect. FIGS. 47 and 48 show a generally similar design, with the slotted push-plate 62 here, however, being inserted from the inside into a slot-shaped cut-out in the support plate 8 which is deeper than the width of the slotted push-plate so that the slotted push-plate 62 can first be inserted to such a depth that the drive shaft goes into the support plate cut-out 50. The slotted push-plate 62 is then advantageously pushed radially inwardly into the groove by a cone or an eccentric screw 63 and is clamped, cf. FIGS. 47 and 48. In this respect, it is also generally possible to work oppositely and first to lower the slotted push-plate 62 in a shaft groove which is too low and then to clamp it outwardly into the support plate slot.

To achieve a particularly reliable elimination of any play between the drive shaft 6 and the support plate 8, an expansion of the shaft cross-section can also be provided which presses the shaft section plugged in the helical support plate cut-out 50 with the support plate 8, as FIGS. 49 and 50 show. For this purpose, the drive shaft 6 has a preferably conical end-face cut-out into which an expansion cone 64 can be axially inserted to expand the shaft contour. For this purpose, for example, the expansion cone can be pulled into the shaft cut-out by a clamp screw. Alternatively or additionally, the expansion cone can be pressed in. In this respect, the drive shaft can advantageously be expanded up to and into the plasticization range so that a joint pressing occurs. This can advantageously be in connection with an eccentric expansion which can be achieved by a corresponding insertion direction of the expansion cone 64. Alternatively, however, it is also possible to work with a central expansion achievable by a central introduction of the expansion cone 64. The connection is releasable again in the resilient deformation region depending on the cone angle.

FIGS. 51 and 52 show an alternative drive shaft/support plate connection. The shaft section seated in the support plate cut-out 50 accordingly has a plurality of cylindrical steps 65, which are preferably also slightly conical and which are preferably arranged within the helical contour or within the helical envelope area of the drive shaft 6 continuing the actual helical contour so that they can be worked out of the helical contour in a cutting manner or in another manner. In this respect, the steps are preferably offset with respect to one another with regard to their respective geometrical axes, cf. FIG. 51, so that torques can be transmitted via the steps of the support plate cut-out 50 formed in a congruent manner. This design of the drive shaft/support plate connection advantageously permits a linear, right-angled or axis-parallel pressing-on procedure as well as a simple production process. Radial play can be eliminated by a slightly conical formation of the steps at the drive shaft and/or at the support plate cut-out. The axial security can be provided separately, for example formed in the manner of a screw nut which is screwed onto the shaft end and is tensioned against the support plate 8, cf. FIG. 52.

Alternatively to such steps, in the region of its shaft section plugged into the support plate 3, the drive shaft 6 can also have peripheral surface sections 66 and 67 which are offset eccentrically to one another and which can in particular be formed by unilateral conical chamfer of the otherwise helical contour of the drive shaft 6. The support plate cut-out is made in a complementary manner thereto. Torques can also be transmitted by the offset of the two peripheral surface sections 66 and 67. The drive shaft is axially secured as before by a screw nut and is tensioned at the support plate.

FIGS. 55 and 56 furthermore show a pin connection between the drive shaft 6 and the support plate 8, with a helically contoured shaft section of the drive shaft 6 also being seated in the likewise helical support plate cut-out here. A plurality of pins 68, preferably threaded pins, are advantageously introduced outside the fluid guidance between the support plate 8 and the drive shaft 6, with the pins 68 being screwed into the support plate 8 radially from the outside in the embodiment drawn until they engage into the drive shaft 6, cf. FIG. 56.

The piston 3 of the rotary motor can generally have different designs. FIGS. 7 and 8 show an advantageous multi-part embodiment of the piston 3. A piston carrier 19 is made in ring shape and forms the outer jacket surface of the piston 3 with its radially outwardly disposed section. At the end face, the piston carrier 19 has two circular recesses into which a respective two inner half-shells 20 and 21 can be inserted which together respectively form a circular shell whose inner jacket surfaces together form the shaft passage cut-out 10. The inner sealing ring 12 can advantageously be inserted between the inner half-shell pairs 20 and 21 placed on at the end face.

The one-piece piston carrier 19 in this respect advantageously has an inner diameter which is sufficiently large to be pushed over the end-face support plate 8 of the drive shaft 6.

FIGS. 9 and 10 show an alternative piston embodiment, likewise in multiple parts. Here, the piston 3 consists of two piston half-shells 22 and 23 which can be placed onto one another in the radial direction. The joint 24 advantageously extends in arcuate form, as FIG. 9 shows. It can in particular follow the likewise arcuate extent of the shaft passage cut-out 10 which corresponds to the helical extent of the drive shaft 6. The two piston half-shells 22 and 23 can be screwed to one another via screws 25 and centering sleeves 26.

As FIG. 9 shows, two respective inner sealing rings 12 and two outer sealing rings 13 are provided at the piston 3 in the embodiment shown.

Alternatively, the piston 3 can also be made in one piece. FIGS. 11 and 12 show such an embodiment, with this requiring the corresponding releasable connection of the drive shaft 6 to the support plates 8 or a formation of the bearing pin or output shaft pin inside the inner envelope of the drive shaft 7, as is described in connection with FIGS. 30 to 32. A respective two axially mutually spaced apart inner seals 12 and outer seals 13 are also provided here which each extend in ring shape around the corresponding outer jacket surface and inner jacket surface respectively of the piston. This can advantageously be used to fill annular pressure pockets 27 and 28 respectively formed between a pair of sealing rings with hydraulic pressure or pneumatic pressure from the respectively pressure-charged pressure chamber 4 or respectively. For this purpose, corresponding feed bores 29 are formed in the piston which open into the end faces of the piston 3, on the one hand, and open into the named pressure pockets 27 and 28 on the jacket surfaces of the piston between the sealing rings, on the other hand. The connection of the feed bores 29 can be controlled with the respective pressure side via a valve 30, cf. FIG. 11. On the one hand, the induces radial forces can be taken up at least partially via such pressure pockets 27 and 28 fed from the pressure chambers 4 and 5 respectively and, on the other hand, the friction can be substantially reduced, which considerably improves the efficiency of the rotary motor.

As FIG. 13 shows, the piston 3 can also have an oval cylindrical shape. The piston space can hereby, on the one hand, be used better by the displacement of the force engagement point. On the other hand, the error lever toward the flat side of the piston becomes smaller. A larger shaft jump can in particular be achieved with a balanced piston. It must furthermore be noted that, with the oval shape of the piston shown in FIG. 13, the envelope 31 of the helically curved drive shaft 6 is set better, i.e. over a longer curve section, at the inner jacket surface of the housing 1. However, a better support of the drive shaft 6 at the housing 1 can be achieved, which is in particular of significance with longer construction shapes where the axial forces can induce larger shaft bends.

As FIG. 14 shows, the drive shaft 6 can also have an oval or ellipsoid cross-section. This improves the stability of the drive shaft 6 in the bending direction. The flat side of the oval or ellipsoidal cross-section of the drive shaft 6 can nestle better to the likewise oval or ellipsoid inner jacket surface of the housing 1, whereby a better support is achieved.

The support effect can furthermore be improved in that the inner jacket surface of the housing 1 which is—simplistically stated—made in oval shape undergoes a restriction centrally so that the narrow side is drawn better to the envelope 31 of the drive shaft 6, as FIG. 15 shows.

As FIG. 16 shows, the drive shaft 6 can also be given an egg-shaped or polygonal cross-section which is made thicker toward the envelope outer side and thinner toward the inner side, whereby the drive shaft 6 is optimized with respect to its bending stiffness and torsion stiffness. The housing 1 and the outer jacket surface of the piston 3 also have such a polygonal cylindrical contour which is made thicker toward the one side and narrower toward the side at which the drive shaft 6 is supported. However, a compact cylinder balanced with respect to the forces can be achieved.

To achieve an end position damping and/or also a continuous adjustment of the end position of the piston 3, an adjustable control slide 32 can be provided in the manner shown in FIG. 17, said control slide being associated with the pressure medium supply line and drain lie 33 via which the pressure chamber 4 or 5 can be filled and emptied. The opening cross-section of the named line 33 can be varied via the control slide 32. If it is fully closed, as FIG. 17 shows, the piston 3 cannot move further to the left; it has reached its end position.

Two rotary motors can be synchronized in a simple manner with respect to their rotary movements via the pressure medium via the control scheme shown in FIG. 18. The two rotary motors can advantageously be made identical to one another and can substantially correspond to the embodiment in accordance with FIGS. 1 to 3. The pressure chambers 4 and 5 of the respective motors are each filled via a common pressure line 34 or 35 which forks via a flow splitter 36 and leads into the respective pressure chambers 4 or 5 of the two motors.

FIG. 19, in contrast, shows an embodiment of a rotary motor with two drive shafts 6 mechanically synchronized via a common piston 3. As FIGS. 19 and 20 show, the piston 3 in this embodiment advantageously has a pressed-flat cross-section; it can in particular be made in oval cylindrical or ellipsoid cylindrical form so that the two drive shafts 6 can be arranged at the resulting flat sides of the correspondingly formed housing 1. The common piston 3 in this case has two shaft passage cut-outs 10 with which the piston 3 slides displaceably on the two drive shafts 6.

The two drive shafts 6, which are each formed helically in the previously described manner, are advantageously offset with respect to one another in the helical threads so that shaft sections curved in opposite directions plug in the two shaft passage cut-outs 10. The radial forces which arise and which are induced in the piston 3 by the shaft are hereby compensated.

As FIGS. 19 and 20 show, with such a double shaft embodiment of the motor, a guide rod 37 can advantageously be inserted centrally in the inner space of the housing 1, said inner space connecting the two end-face housing covers or support covers 2 to one another. The piston 3 has a corresponding cut-out which is seated slidingly on the named guide rod 37. The guide rod 37 causes, in addition to the piston guidance, a force reception for the hydraulic pressure in that it advantageously connects the end-face housing sections. In addition, it reduces the piston area, which can in particular be of significance with very large motor designs.

In this respect, different advantages can be achieved by different arrangements of the shaft profiles relative to one another. Whereas the installation position shown in FIG. 20 permits a large axial spacing of the two shafts with compact external dimensions, the shafts can also be arranged in accordance with a further preferred embodiment of the invention as shown in FIG. 20A to achieve a transverse force compensation. As FIG. 20A shows, the forces F1 and F2 acting on the piston from the shafts act against one another in the installation position of the shafts shown there so that the resulting support reaction force corresponds approximately to zero. The axes of rotation 7 of the drive shafts 6 are, in this respect, not disposed on the straight connection lines between the two shaft passage cut-outs, but are laterally offset thereto, cf. FIG. 20A.

FIGS. 21 and 22 so-to-say show the kinematic reversal of the helical design of the drive shaft 6. In this embodiment, the drive shaft 6 is admittedly likewise made as a crankshaft; however, it has a straight extent which is offset with respect to the axis of rotation 7 of the drive shaft and extends parallel to the named axis of rotation 7, cf. FIG. 21. The piston 3 is likewise axially displaceably seated, with a cylindrical shaft passage cut-out 10 in this case, in a sliding manner on the named drive shaft 6. To drive the drive shaft 6 in accordance with the crank principle, the inner jacket surface of the housing 1 is turned or screwed into itself spirally or helically around the axis of rotation 7 of the drive shaft 6 so that the piston 3 executes a helical rotation around the axis of rotation 7 on an axial displacement. The drive shaft 6 is hereby rotated in a corresponding crank manner.

To be able to adapt the output speed or the output angle of rotation and the achievable output torques to the requirements even with a given overall housing length and shaft pitch, an output step-up or step-down transmission 38 can be integrated into the housing 1 and/or into the support cover 2, as shown in FIG. 23. The support plate 8 supporting drive shaft 6 can in particular have an end toothed arrangement which meshes with an output pinion 39 which drives an output shaft 40 which is likewise supported at the support cover 2 closing the housing 1 at the end-face side and which passes through it, cf. FIG. 23.

FIGS. 24 and 25 show an embodiment which is generally similar to that of FIGS. 1 to 3 and corresponds to it in further areas. Alternatively to the embodiment shown in FIGS. 1 to 3, the drive shaft 6 is not rigidly connected to the support disks or support plates 8, but is connected to them in the manner of a ball joint.

In a similar way to the embodiment in accordance with FIGS. 11 and 12, FIGS. 26 and 27 also show a one-part piston in which two inner seals 12 and outer seals 13 are provided which are spaced apart from one another axially and which each extend in ring shape around the corresponding outer jacket surface or inner jacket surface respectively of the piston. Unlike the embodiment in accordance with FIG. 11, in addition to the seals extending in the peripheral direction, axially extending sealing elements are provided which connect the two axially spaced apart seals 12 and 13 to one another on oppositely disposed sides of the piston (cf. FIG. 27). The pressure pockets 27 and 28 extending between the seals 12 and 13 in the peripheral direction are divided by the named axial sealing webs 12a and 13a so that they are disposed in semi-annular form on oppositely disposed peripheral sides. The pressure pockets can hereby be fed from the pressure chambers 4 or 5 respectively depending on which side the pressure is applied to the piston 3. As FIGS. 26 and 27 show, the named pressure pockets 27 and 28 are fed once via feed bores 29a and 29b from the pressure chamber 4 and once from the pressure chamber 5.

FIGS. 28 and 29 show a corresponding piston design to FIGS. 26 and 27. In contrast to this, however, no seals spaced apart from one another and extending in the peripheral direction are provided, but only one such seal which is, however, offset by an S-shaped extent, cf. FIG. 28, or, simply also an only diagonal extent sectionally on the side facing the pressure chamber 4 and in an oppositely disposed section on the side of the piston 3 facing the pressure chamber 5, and indeed in each case over approximately half the periphery of the piston. Two sector-shaped pressure pockets which are fed in the named manner from the different pressure chambers 4 and 5 are likewise divided from one another via this S-shaped extent or diagonal extent, as FIG. 28 shows.

In the embodiment of the present invention shown in FIG. 30, mutually oppositely disposed pressure pockets are likewise formed between the piston 3 and the housing 1 and between the piston 3 and the shaft 6 and are, however, in the drawn embodiment, bounded by a respective ring-shaped seal 13 and 12 which in each case extends diagonally over the piston periphery, as FIG. 30 shows. The pressure pockets are hereby given an oblique wedge-like design in which the depth of the pressure pockets increases or reduces in opposite directions considered in the peripheral direction. It is understood that the one pressure pocket is also in pressure communication with the one piston side and the other pressure pocket with the other piston side here so that when the one pressure chamber is charged with pressure, the one pressure pocket is fed and, when the other pressure chamber of the rotary motor is charged with pressure, the other pressure pocket is fed. A corresponding pressure relief can also be achieved here.

The embodiment of the rotary motor shown in FIG. 30 furthermore differs by the design of the shaft 6 and of the output shaft pins 9 connected thereto. As FIGS. 31 and 32 show, the shaft 6 has a relatively large shaft diameter with a relatively small eccentricity of the axis of rotation 7. The support or drive shaft pins 2 are advantageously formed in the interior of the inner envelope section of the shaft 6 and can hereby be shaped integrally in one piece at the shaft body. In FIG. 32, the reference numeral 41 designates the inner envelope section of the shaft 6 within which the named support or output shaft pin 9 extends.

As FIG. 30 shows, the shaft 6 in the drawn embodiment is fastened via two roller bearings 42 to the housing covers which can be connected rigidly to the housing 1 in this embodiment. The shaft 6 is in particular clamped between two tapered roller bearings which shorten the effective support spacing relevant for the bend of the shaft. The support covers can be clamped to one another or to the housing 1 via clamp screws 43. The respective support cover is sealed via seals 44 and 45 with respect to the support or output shaft pins 9, on the one hand, and with respect to the housing, on the other hand.

FIG. 57 shows a particularly advantageous design of the rotary motor. In an advantageous embodiment of the invention, the housing or the support of the shaft is made such that the drive shaft 6 can be removed axially at one side of the housing 1 together with the piston 3 seated thereon and together with the support cover 8, whereby the piston and the seals can be made accessible in a simple manner for the purpose of changing a seal or of servicing. Advantageously, a second support plate does not have to be dismantled at all for this purpose. The motor can so-to-say have an asymmetrical design overall in this respect, in particular with respect to the end-face support sites.

The drive shaft 6 is in this respect differently supported at its two ends, namely by a fixed support at one end and a loose support at the other end so that the shaft is only axially fixed at one side. A statically defined support of the shaft is hereby achieved with an overall compact structure with a play-free taking up of the axial forces. This compact structure is in particular very advantageous on the use of the rotary motor as a bucket drive due to the very tight space conditions there.

To achieve a favorable installation with a simple production and a favorable force output, the shaft is advantageously supported at the housing 1 at one end by means of a support plate or support disk 8 in one of the aforesaid embodiments, with a releasable connection in accordance with one of the afore-described embodiments in accordance with FIGS. 33 to 56 preferably being able to be provided between the support plate and the shaft. The support site formed by the support plate 8 forms the fixed support of the drive shaft 8. At the oppositely disposed end, in contrast, the drive shaft 6 has a shaft start 69 which is shaped on integrally in one piece, which is seated in a housing cover at the end-face side and which forms the loose support of the drive shaft 6. The shaft start 69 in this respect has a larger diameter than the helical crankshaft section of the drive shaft 6 and can in particular approximately correspond to the imaginary cylindrical envelope surface which inscribes the helix of the drive shaft 6 and which can in turn correspond to the original shaft blank contour from which the shaft is worked. In a further development of the invention, security against excess pressure 70 is provided between the two pressure chambers 4 and 5 of the motor which has at least one excess pressure passage 71 connecting the two pressure chambers and which is closed in the normal case, i.e. at pressures below a preset threshold value, by an excess pressure valve 72 which only opens when the named threshold value is exceeded. The security against excess pressure can generally be integrated into the shaft in the form of a shaft cut-out, as FIG. 57 shows. The security against excess pressure can advantageously, however, alternatively or additionally also be integrated into the piston 3, which in particular facilitates the introduction of the excess pressure passage 72 with a helical extent of the shaft. In order also to be able to adjust the excess pressure valve 72, which is advantageously adjustable with respect to its opening pressure, from the outside, in the drawn embodiment an access site in the form of a closing screw 72 is provided in one of the housing covers at the end-face side and the excess pressure valve 72 provided at the piston 3 can be actuated through the housing from the outside by said closing screw, cf. FIG. 57.

As FIG. 57 shows, the seals 12 and 13 provided outwardly and inwardly at the piston each have a diagonal extent, whereby the shearing off effect of oil is provided against. A lubrication film cushion is built up by the constant contact change with a right/left running due to the lubrication film pockets which are filled continuously and which are automatically sealed at the cylinder wall on the load change.

1. A rotary motor, preferably a pivot drive for construction machinery, hoisting gear, trucks and the like, comprising an elongate, approximately tubular housing (1), at least one piston (3) which is axially displaceably received in the housing (1) and which can be axially driven by the charging of a pressure medium in a pressure chamber (4, 5) as well as at least one shaft (6) which is received axially fixedly in the housing (1) and rotatably around an axis of rotation (7) with the piston (3) having a shaft passage cut-out (10) by which the piston (3) is axially displaceably seated on the shaft (6), characterized in that the shaft (6) forms a crankshaft whose axis of rotation (7) is offset with respect to the shaft passage cut-out (10) of the piston (3), with the shaft passage cut-out (10) being arranged centrally in the piston (3) with respect to the piston cross-section and with the piston (3) being rotatably with respect to the housing (1).

2. A rotary motor in accordance with the preceding claim, wherein the shaft (6) has a helical extent around its axis of rotation (7).

3. A rotary motor in accordance with claim 1, wherein the shaft (6) has a straight extent parallel to its axis of rotation (7).

4. A rotary motor in accordance with claim 1, wherein the housing (1) has a spirally rotated inner jacket surface.

5. A rotary motor in accordance with claim 2, wherein the housing (1) has a circular cylindrical inner jacket surface.

6. A rotary motor in accordance with claim 1, wherein the shaft (6) has a circular cross-section and the piston (3) has a circular outer peripheral contour.

7. A rotary motor in accordance with claim 1, wherein the shaft passage cut-out (10) in the piston (3) is adapted to the cross-section of the shaft (6), in particular corresponds to the shaft cross-section, and/or is adapted in its axial extent to the axial extent of the shaft contour.

8. A rotary motor in accordance with claim 1, wherein a surface pair effecting the axially displaceable guidance and/or the radial force support of the piston (3) at the piston (3) and at the housing (1) and/or at the piston (3) and at the shaft (6) simultaneously forms a sealing surface pair for the sealing of the pressure chamber (4, 5) for the pressure charging of the piston (3).

9. A rotary motor in accordance with claim 1, wherein a seal (12) is inserted between the shaft (6) and the shaft passage cut-out (10) in the piston (3) and/or a sealing (13) is inserted between the outer jacket surface of the piston and the inner jacket surface of the housing, with the seal (12), (13) being formed such that pressure pockets (27, 28) which can be fed from the pressure chamber (4, 5) are formed between the piston (3) and the housing (1) and/or between the piston (3) and the shaft (6).

10. A rotary motor in accordance with the preceding claim, wherein mutually oppositely disposed peripheral sectors (41), (42) at the outer jacket surface of the piston and/or at the inner jacket surface of the shaft passage cut-out (10) are bounded in the peripheral direction of the piston (3) by axially extending sealing elements and/or sealing element sections (43, 44) and each form a pressure pocket (27, 28) of which the one is in pressure or flow communication with the one piston end-face side and the other is in pressure or flow communication with the oppositely disposed piston end-face side, with mutually oppositely disposed peripheral sectors (41, 42) at the outer jacket surface of the piston and/or at the inner jacket surface of the shaft passage cut-out (10) are bounded by a sealing element extending diagonally over the piston periphery and each form a pressure pocket (27, 28) of which the one is in pressure or flow communication with the one piston end-face side and the other is in pressure or flow communication with the oppositely disposed piston end-face side.

11. A rotary motor in accordance with claim 1, wherein a roller bearing is provided between the housing (1) and the piston (3) and/or between the piston (3) and the shaft (6).

12. A rotary motor in accordance with claim 1, wherein the piston (3) is made in multiple parts such that each piston part per se can be pushed over a support stump at a crankshaft end.

13. A rotary motor in accordance with the preceding claim, wherein the piston (3) has a ring-shaped piston carrier (19) which at least partly forms the outer jacket surface of the piston and onto which at least one inner half-shell pair can be set at the end-face side which forms the shaft passage cut-out in the assembled state.

14. A rotary motor in accordance with claim 1, wherein the piston (3) has equally large effective piston surfaces at it two oppositely disposed end-face sides.

15. A rotary motor in accordance with claim 1, wherein the housing (1) and the support of the shaft (6) at the housing are made such that the shaft (6) can be axially removed from the housing (1) together with the piston seated thereon, in particular also together with a support disk (8) secured to the shaft.

16. A rotary motor in accordance with claim 1, wherein the shaft (6) is made differently and/or is differently supported at its two ends.

17. A rotary motor in accordance with the preceding claim, wherein the shaft (6) is supported at the housing (1) at one end by an axial fixed bearing and at its other end by an axial loose bearing.

18. A rotary motor in accordance with claim 1, wherein the shaft (6) is supported at least one of its two ends in each case at a support plate and/or support disk (8) which respectively bounds a pressure chamber (4, 5) at the end-face side and/or can be charged by the pressure in the pressure chamber (4, 5), with the shaft (6) extending into a cut-out in the support plate and/or support disk (8) and transmitting torque via the cut-out over the fully area onto the support plate and/or support disk (8).

19. A rotary motor in accordance with the preceding claim, wherein the cut-out in the support plate and/or support disk (8) has a helical extent into which the likewise helical extent of the shaft (6) extends, with the helical shaft section seated in the cut-out being axially and/or radially fixed, preferably anchored, with respect to the cut-out by a shape matching element.

20. A rotary motor in accordance with claim 18, wherein the shaft (6) has a plurality of respectively circular cylindrical steps and mutually eccentrically offset steps in the region of the cut-out of the support plate (8) which are disposed inside its helical extent and which can be clamped against the support plate.

21. A rotary motor in accordance with claim 1, wherein the shaft (6) has a preferably integrally shaped support and/or output shaft pin (9) which extends inside an inner envelope surface of the shaft section and/or whose diameter (d_{L}) approximately corresponds to the shaft diameter (d_{w}) less double the shaft eccentricity (ε), that is d_{L}=d_{w}−2ε.

22. A rotary motor in accordance with claim 1, wherein the shaft (6) has a preferably integrally shaped support and/or output shaft pin (9) which is larger than a shaft diameter and substantially corresponds to an outer envelope surface of the shaft section and/or whose diameter d(_{L}) approximately corresponds to the sum of the shaft diameter (d_{w}) and four times the shaft eccentricity (ε), also d_{L}=d_{w}+4ε.

23. A rotary motor in accordance with claim 1, wherein feedable pressure pockets are formed at the support sites of the shaft (6) between the housing (1) and the support section at the shaft side, wherein mutually oppositely disposed peripheral sectors at the inner jacket surface of the shaft support cut-out of the housing and the associated support pin at the shaft side are bounded by axially extending sealing elements and/or sealing element sections in the peripheral direction of the support pin and each form a pressure pocket of which the one or the other can be brought into communication with the adjoining pressure chamber in dependence on the rotary drive direction.

24. A rotary motor in accordance with claim 1, wherein the piston (3) is made from a dry sliding material, preferably a wear-resistant and low-friction synthetic material, preferably a ceramic material and/or plastic.

25. A rotary motor in accordance with claim 1, wherein the piston (3) is made in a resilient manner in at least one load direction of the rotary motor such that the piston (3) forms a damping element in the named at least one load direction.

26. A rotary motor in accordance with claim 1, wherein the at least one pressure chamber (4, 5) is in communication with an excess pressure line whose flow through an excess pressure valve is controlled, with the excess pressure line and the excess pressure valve advantageously being arranged in the piston (3).

27. A rotary motor in accordance with the preamble of claim 1, wherein two shafts (6) are provided whose respective axis of rotation (7) is respectively offset with respect to the associated shaft passage cut-out (10) of the piston, with the two shafts (6) being received in two shaft passage cut-outs (10) in a common piston (3) which are arranged symmetrically with respect to a cross-sectional centre of area of the piston (3).

28. A rotary motor in accordance with the preceding claim, wherein the two shafts (6) each have a helical extent around their axis of rotation which has a thread offset with respect to the respective other helical extent such that the shaft sections seated in the shaft passage cut-outs (10) are curved in opposite senses and/or the forces (F1, F2) exerted on the piston (3) by the named shaft sections compensate one another.

29. A rotary motor in accordance with the preamble of claim 1, wherein the shaft (6) forms a crankshaft whose axis of rotation (7) is offset with respect to the shaft diameter cut-out (10) of the piston (3), wherein the shaft (6) has an oval, ellipsoid or polygonal cross-section.

30. A rotary motor in accordance with the preamble of claim 1, wherein the shaft (6) forms a crankshaft whose axis of rotation (7) is offset with respect to the shaft diameter cut-out (10) of the piston (3), wherein the piston has an oval, ellipsoid or polygonal outer peripheral contour.

31. A rotary motor, preferably a pivot drive for construction machinery, hoisting gear, trucks and the like, comprising an elongate, approximately tubular housing (1), at least one piston (3) which is axially displaceably received in the housing (1) and which can be axially driven by the charging of a pressure medium in a pressure chamber (4, 5) as well as at least one shaft (6) which is received axially fixedly in the housing (1) and rotatably around an axis of rotation (7) with the piston (3) having a shaft passage cut-out (10) by which the piston (3) is axially displaceably seated on the shaft (6), wherein the features of at least claim 2 are furthermore provided.
